(19) United States
(12) Patent Application Publication
(10) Pub. No.: US 2014/0072855 A1
(43) Pub. Date: Mar. 13, 2014

(54) ENERGY STORAGE APPARATUS, ENERGY STORAGE CELL AND HEAT-CONDUCTING ELEMENT

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 14/004,561

(22) PCT Filed: Feb. 23, 2012
(86) PCT No.: PCT/EP12/00782

§ 371 Date: Nov. 22, 2013

(30) Foreign Application Priority Data
Mar. 11, 2011 (DE) 10 2011 013 617.7

(51) Int. Cl. H01G 2/08; H01M 10/50

(52) U.S. Cl. CPC H01G 2/08; H01M 10/5053
USPC 429/120; 361/502

(57) ABSTRACT

The invention relates to an energy storage device comprising a plurality of storage cells and a temperature control device for controlling the temperature of the storage cells or a cell assembly formed by the storage cells. Elastic means are arranged between a storage cell and another component for shock-absorbing bearing or for arranging them at a distance from each other. The other component is another storage cell or a holding element or another housing part or a heat-conducting element. Said elastic means are configured and designed as a functional component part of the temperature control device. Storage cells and heat-conducting elements which are suitable for use in the claimed energy storage device are also described.

The entire content of the priority application DE 10 2011 013 617 hereby becomes a constituent of the present application by reference.

The invention relates to an energy storage apparatus, an energy storage cell and a heat-conducting element.

It is known that a battery for use in motor vehicles, particularly in motor vehicles with a hybrid drive or in electric vehicles, has a plurality of cells, for example lithium ion cells, electrically connected in series and/or parallel.

The cells often have to be cooled in order to dissipate the resultant lost heat. To this end, it is known to use an indirect cooling by means of a coolant circuit or a direct cooling by means of pre-cooled air which is conducted between the cells. In the case of cooling by means of the coolant circuit, a metallic cooling plate, through which coolant flows, can be arranged on the cell block of the battery, often below the cells. The lost heat is conducted from the cells to the cooling plate either via separate heat-conducting elements, e.g. heat-conducting rods or plates, or via correspondingly thickened cell housing walls of the cells. Often, the cell housings of the cells are realised metallically and an electric voltage is present at them. To prevent short circuits, the cooling plate is separated from the cell housings by means of electrical insulation, for example a heat-conducting film, a moulding, a casting compound or a coating or film applied to the cooling plate. The coolant circuit can also be used to heat the battery, e.g. in the case of a cold start.

Various batteries of this type are known already. For example, batteries are known from DE 10 2008 034 869 A1, the cells of which are constructed as so-called pouch cells, the active part of which, which is constructed essentially cuboidally, is surrounded in an envelope film (or a pair of envelope films) in the manner of a sandwich and welded in a sealed manner, wherein the envelope film constructs a surrounding sealing seam and wherein the cell poles are constructed by contacts which pass through the sealing seam on the upper side of the cells and project upwards. Cooling plates are arranged between the cells, which bear against the flat sides of the cells, are angled below the cells in each case and there bear on a cooling plate. The heat generated in the cell can be emitted to the cooling plate. A heat transfer agent flows through the cooling plate and transports the heat to an external heat exchanger. Batteries are known form the same published document, the cells of which are constructed as so-called flat cells which are formed essentially cuboidally and arranged in the manner of a stack one behind the other on a cooling plate and clamped with the same, wherein an electrically conductive side wall of the cells, which is used as cell pole, is in each case angled on the underside which faces the cooling plate, in order to construct a heat transfer surface to the cooling plate located there, which is as large as possible. The cells are clamped to one another in both cases by means of a clamping device, for example by means of a separate clamping plate and/or by means of clamping straps, and pressed onto the cooling plate.

A battery is known from WO 2010/081704 A2, in which a plurality of cells are clamped in a coffee bag construction between frame elements with the aid of two pressure frames and a few tie bolts. It is known from the same published document to provide resilient elements between successive cells in a battery block. Thus, mechanical effects on the flat sides of the cells can be attenuated and relative movements and also thermal expansion can be compensated.

It is an object of the present invention to improve the structure according to the prior art.

The object is achieved by the features of the independent claims. Advantageous advancements of the invention form the subject of the subclaims.

According to one aspect of the present invention, an energy storage apparatus is suggested, which has a plurality of storage cells and a temperature control device for controlling the temperature of the storage cells or a cell composite formed by the storage cells, wherein elastic means for shock absorbing storage or spacing are provided between a storage cell and another component, wherein the other component is a different storage cell or a holding element or some other housing part or a heat-conducting element, and wherein the elastic means are designed and set up as a functional constituent of the temperature control device.

In the sense of the invention, an energy storage device is understood to mean a device which is also able to accept, to store and re-emit electrical energy in particular, if necessary by making use of electrochemical processes. In the sense of the invention, a storage cell is understood to mean an inherently closed functional unit of the energy storage apparatus which in itself is also able to accept, to store and re-emit electrical energy in particular, if necessary by making use of electrochemical processes. A storage cell can for example, but not only, be a galvanic primary or secondary cell (in the context of this invention, primary or secondary cells are termed battery cells without making a distinction and an energy storage apparatus constructed therefrom is termed a battery), a fuel cell, a high performance capacitor, such as a supercap or the like, or an energy storage cell of a different type. In particular, a storage cell constructed as a battery cell for example has an active region or active part, in which electrochemical conversion and storage processes take place, a housing for encapsulating the active part from the surroundings and at least two current contacts which are used as electric poles of the storage cell. The active part for example has an electrode arrangement, which is preferably constructed as a stack or winding with current collecting films, active layers and separator layers. The active and separator layers can be provided at least to some extent as separate film blanks or as coatings of the current collecting films. The current contacts are electrically connected to the current collection films or formed by the same.

A storage cell can also be a cell which accepts and/or emits energy not as electrical, but rather as thermal, potential, kinetic or some other energy type, or a cell which accepts energy in one energy type and re-emits it in a different energy type, wherein the storage can take place in yet another energy type.

In the sense of the invention, temperature control is understood to mean a dissipation or supply, particularly dissipation, of heat. It can be realised as a passive cooling, for example by heat radiation at heat radiation surfaces, as an active cooling, for example by means of forced convection at heat exchange surfaces, or by means of heat exchange with an in particular circulating heat transfer agent, such as for example water, oil or the like in a heat exchanger. In this case, a control or regulation can be provided, in order to keep to a predetermined reliable temperature range. In the sense of the invention, a temperature control device can be understood to mean a device for the simple temperature exchange within the energy storage apparatus or for exchanging heat with surroundings.

In the sense of the invention, an elastic means can in particular be understood to mean a component which can also ward off relative movements between storage cells, if appropriate also between storage cells and other components. It can therefore also particularly be a damping element, for example but not only in the form of a cushion, a strip, a layer or the like.

If the elastic means are designed and set up as a functional constituent of the temperature control device, constructive limitations with regards to the position and use of such elastic means can be overcome. Such limitations often exist, as damping elements often consist of thermally insulating materials, which have a very low heat conductivity, such as for example PU foam, foam rubber, corrugated cardboard or the like, and thus may stand in the way of an efficient heat dissipation.

In a preferred embodiment, the elastic means may have a heat-conducting shell and an interior, wherein the interior is filled with an elastically resilient material. In a further preferred embodiment, the elastic means can be constructed from a heat-conducting and elastically resilient material. In a further preferred embodiment, the elastic means may have a heat-conducting or heat permeable shell and an interior, wherein the interior is filled with a heat-conducting and elastically resilient material.

In the sense of the invention, a material is understood as being heat conducting if it has a thermal conductivity which allows use as a heat conductor in the technical sense. In this context, one speaks of a technically usable and constructively intended thermal conductivity, not for example of a minimal and physically unavoidable residual heat conduction, which is also present in inherently heat-insulating materials. A lower limit for a technically usable thermal conductivity can be assumed to be in the range of approximately 10 to 20 Wm⁻¹K⁻¹; this corresponds to the thermal conductivity of high-alloyed steel and a few plastics provided with filler materials which conduct heat well. It is preferable, if the thermal conductivity lies in the range of approximately 40 to 50 Wm⁻¹K⁻¹, which corresponds to that of spring steel (e.g. 55Cr3). Particularly preferably, a thermal conductivity of at least 100 or a few 100 Wm⁻¹K⁻¹ results. By way of example, but not only, silicon for example with 148 Wm⁻¹K⁻¹ or aluminium with 221 to 237 Wm⁻¹K⁻¹ or copper with 240 to 400 Wm⁻¹K⁻¹ or silver with approximately 430 Wm⁻¹K⁻¹ are seen as suitable. Carbon nanotubes, the thermal conductivity of which is specified with approximately 6000 Wm⁻¹K⁻¹ should constitute the currently achievable optimum with regards to this aspect; the use thereof or of the other special materials is to be considered carefully with regards to the costs, the workability and other technical suitability. Against this background, in the sense of the invention, a construction with a heat-conducting material is to be understood to mean that the elastic means or a constituent thereof substantially consists of this material or else, for example for reasons of solidity, electrical insulation, temperature resistance or other properties or purposes, only have one core, a coating or layer, an envelope or the like made up of such a material. By means of a suitable material combination, the desired properties between heat conduction and damping can thus be set. The same materials as those mentioned above, or else other good heat conductors, such as for example ceramics or diamond, are also considered as filler materials for heat-conducting plastics. Thus, inherently thermally insulating foams for example can receive a technically usable thermal conductivity in the range of approximately 10 to 20 Wm⁻¹K⁻¹ by means of doping with such materials. (All information about thermal conductivity at 20° C. according to Hütte, Die Grundlagen der Ingenieurwissenschaften, Springer-Verlag, 31st Edition 2000, Engelkraut et al., Wärmeleitfähige Kunststoffe für Entwärmungsaufgaben, Fraunhofer Institut für Integrierte System and Bauelementetechnologie, version of 15.07.2008, Deutsche Edelstahlwerke, data sheet 1.7176, and Wikipedia, article about “Wärmeleitfähigkeit” [Thermal conductivity], version of 22.02.411; rounding and range summaries, if necessary, the applicant.)

If the elastic means bear preferably planarly at least in certain sections on heat exchange surfaces of the storage cells, a good heat transfer can also be achieved.

In preferred embodiments, the elastic means are constructed in an electrically conductive or electrically insulating manner, in order for example to take account of technical boundary conditions.

In a preferred embodiment, the elastic means are fixed on respective storage cells or constructed as an integral constituent of respective storage cells.

In another preferred embodiment, the elastic means are fixed on respective heat-conducting elements, which are arranged at least in certain sections between respective storage cells, or constructed as an integral constituent of such heat-conducting elements.

Particularly preferably, the temperature control device has a heat exchanger device and heat-conducting elements, which are arranged at least in certain sections between respective storage cells, have heat-conducting contact with the heat exchanger device.

In a further preferred embodiment, a clamping device is provided for clamping the storage cells, wherein preferably, the clamping device is designed and set up as a functional constituent of the temperature control device. In the sense of the invention, clamping is understood to mean securing in a predetermined position, particularly a relative position with respect to one another, by means of clamping forces. During a clamping, elastic and frictional forces can also but not only be utilised.

The clamping incidentally does not preclude a positive-fitting positional fixing; it can, but does not have to limit itself to a prevention of disintegration. If the clamping device is designed and set up as a functional constituent of the temperature control device, the clamping device can also fulfill functions which are associated with the temperature control of the storage cells or the cell composite. These functions can for example, but not only, comprise the heat transfer from and to the storage cells, the heat dissipation via heat radiation surfaces, the heat transfer from and to a heat transfer agent, heat conduction from and to a heat source or heat sink and/or the like. To this end, the clamping device can for example be constructed with a heat-conducting material.

For example, the clamping device has at least one clamping strap which is constructed with the heat-conducting material and which is constructed at least in certain sections in an inherently resilient, for example wave-spring-shaped, manner and/or has a clamping section, such as a turnbuckle or the like, wherein a plurality of clamping straps are preferably provided, of which at least one clamping strap covers at least one other clamping strap. In the sense of the invention, a clamping strap is understood to mean an elongated, in particular flat, strap-like component which can also be used to clamp an arrangement of storage cells with respect to one another, particularly to clamp the same in an embracing manner. In this case, a closure mechanism, a clamping mechanism or the like can be provided, in order to enable assembly under clamping. It is also possible to achieve the exertion of a uniform clamping force on the cell block by means of an inherently resilient construction. An elastic elongation of the clamping strap can be designed in such a manner that the clamping band is oversized compared to the cell block during assembly under prestress and slipped over the same, wherein then, when the prestress is eased off, the clamping strap is positioned securely around the cell block. To this end, the clamping strap can for example be constructed in sections in a wave-spring shaped manner. Particularly advantageously, the sections constructed in a wave-spring shaped manner have planar sections, which under tension bear planarly against heat exchange surfaces of storage cells, heat-conducting elements or the like.

In another embodiment, the clamping device can have a plurality of tie bolts which are constructed with the heat-conducting material. In the sense of the invention, a tie bolt is understood to mean a rod which is constructed in an elongated manner and in particular protrudes beyond an overall length of the cell stack, which clamps the cell block by means of pressure elements such as plates or flanges in particular, which press in a stack direction of the storage cells onto the respective outer storage cells. Usually, a plurality of tie bolts are provided, for example four, six, eight or more. Such tie bolts for example have a head at one end and a thread at the other end or thread at both ends in order to enable a reliable clamping by means of tightening, by means of screwing in or by means of screwing with the aid of nuts. The use of tie bolts also has the advantage, in the case of a corresponding shaping of the storage cells, that storage cells can be threaded onto the tie bolts in a relatively simple manner before prestressing, which can also simplify the assembly. Tie bolts can for example extend through corresponding recesses of frame elements of frame flat cells and accept heat from the same. In this case, the clamping device can further have holding elements and clamping elements, wherein the holding elements are arranged alternately with the storage cells in order to hold the storage cells between them, and wherein the clamping elements clamp the holding elements with the storage cells, wherein the holding elements are thermally coupled at least in certain sections to heat exchange surfaces of the storage cells, and wherein the clamping elements bear at least in certain sections against heat exchange surfaces of the holding elements. In this case, it is advantageous if the holding elements are constructed with a heat-conducting material at least between the contact surfaces with the storage cells and the contact surfaces with the clamping elements. In this manner, a reliable clamping of the holding elements and the storage cells to form a battery block can also be provided. Heat exchange surfaces of the holding elements can be external surfaces, particularly boundary surfaces, of the holding elements, for example but not only if clamping straps are provided as clamping elements. Clamping elements, such as for example but not only tie bolts can also be guided through ducts, for example holes, in the holding elements; in this case, heat exchange surfaces of the holding elements can be formed by inner surfaces of the ducts. Heat exchange surfaces of the storage cells can be provided by flat or boundary sides of the storage cells, by current contacts or at passage regions of current contacts through a housing of the storage cells.

In this case, it is advantageous if the clamping device is thermally coupled at least in certain sections, particularly by means of planar contact, with sections of a heat exchanger device, wherein the heat exchanger device is preferably attached to a heat transfer agent circuit and wherein the heat transfer agent circuit can preferably be controlled or regulated. In this manner, the clamping device can transport heat accepted from the storage cells to the heat exchanger device and there emit the same to a heat transfer agent, such as for example but not only water or oil. The heated heat transfer agent can circulate through the heat transfer agent circuit and emit the accepted heat again at a different location, for example to an air cooler.

Suggested according to further aspects are an energy storage cell, with an active part and a housing surrounding the active part and also with elastic means, which are fixed on the storage cell or are constructed as an integral constituent of the same and are designed and set up for the shock absorbing storage or spacing of the storage cell with respect to the other components; a heat-conducting element for arrangement between energy storage cells, characterised by elastic means which are fixed on the heat-conducting element or are constructed as an integral constituent of the same and which are designed and set up to conduct heat; and a heat-conducting element with an in particular thin-walled carrier structure, particularly for accommodating an energy storage cell, wherein the thin-walled structure outlines a shape of a preferably flat cuboid, and wherein the thin-walled structure has at least one flat side and at least two narrow sides adjoining the flat side, and with elastic means which are fixed on the heat-conducting element or are constructed as an integral constituent of the same and which are designed and set up to conduct heat. Preferably, the elastic means are in each case constructed in accordance with the previous description.

An energy storage device according to the invention, an energy storage cell according to the invention and a heat-conducting element according to the invention are in particular provided for use in a motor vehicle, wherein the motor vehicle is a hybrid vehicle or an electric vehicle in particular.

The previous and further features, objects and advantages of the present invention become clearer from the following description, which has been completed with reference to the attached drawings.

In the drawings:

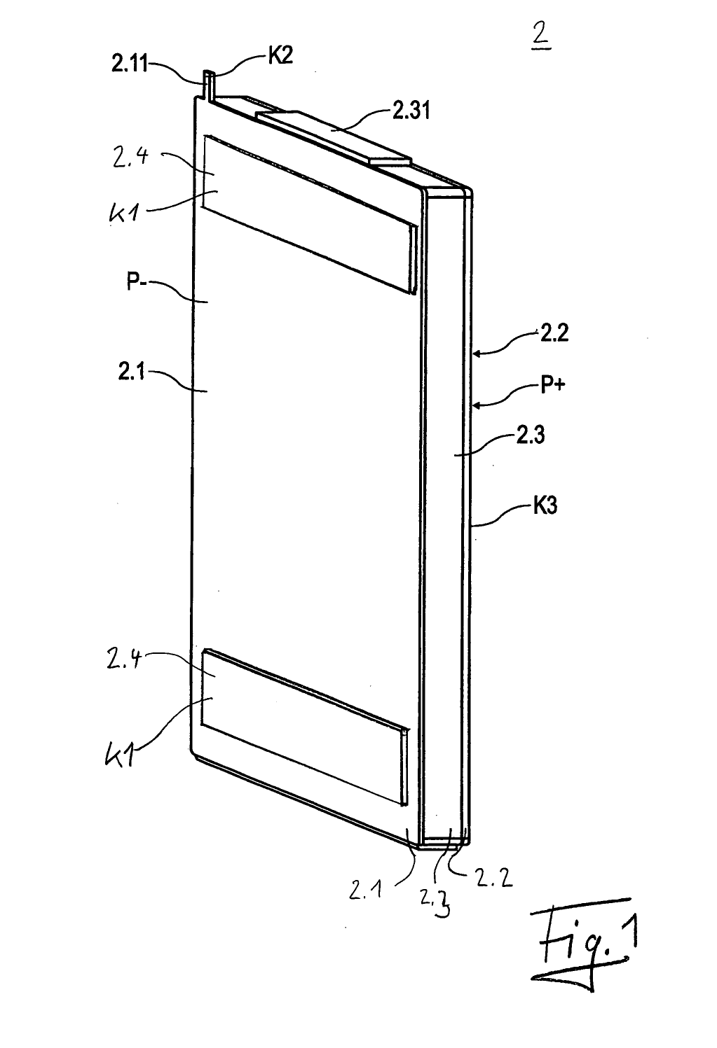

FIG. 1 shows a frame flat cell in a schematic spatial view;

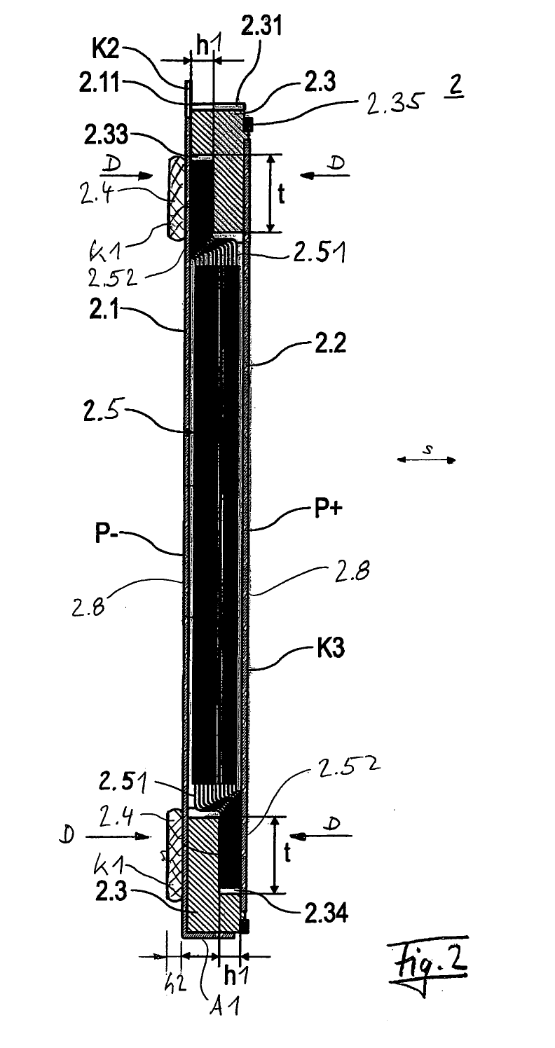

FIG. 2 shows a schematic cross-sectional view of the cell according to FIG. 1;

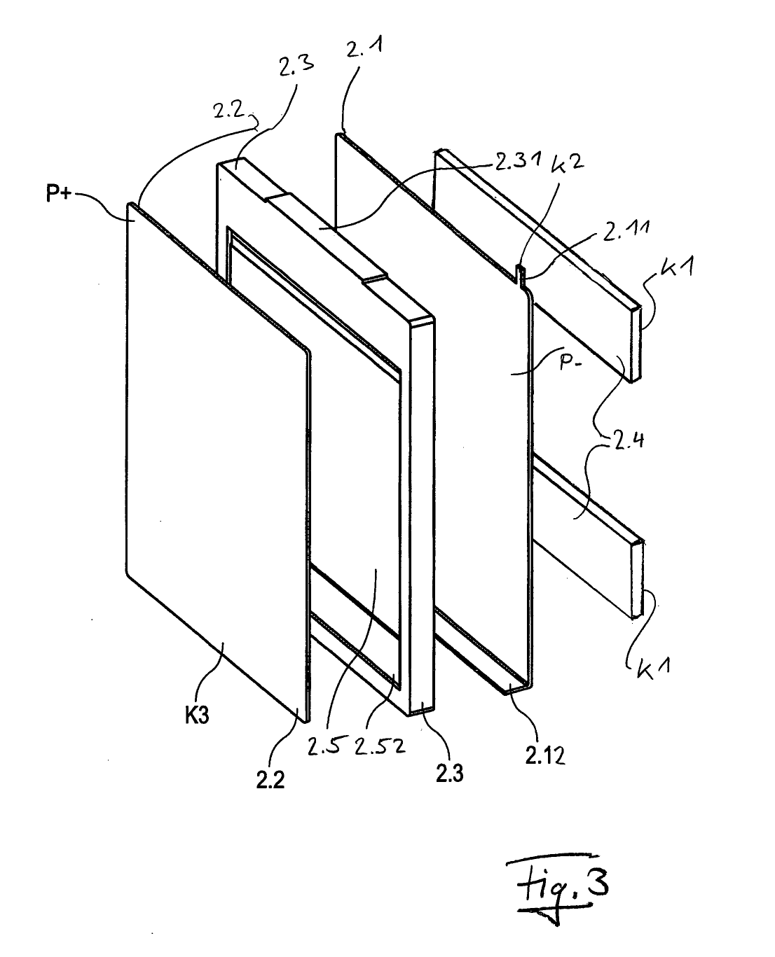

FIG. 3 shows a spatial exploded illustration of the cell according to FIG. 1;

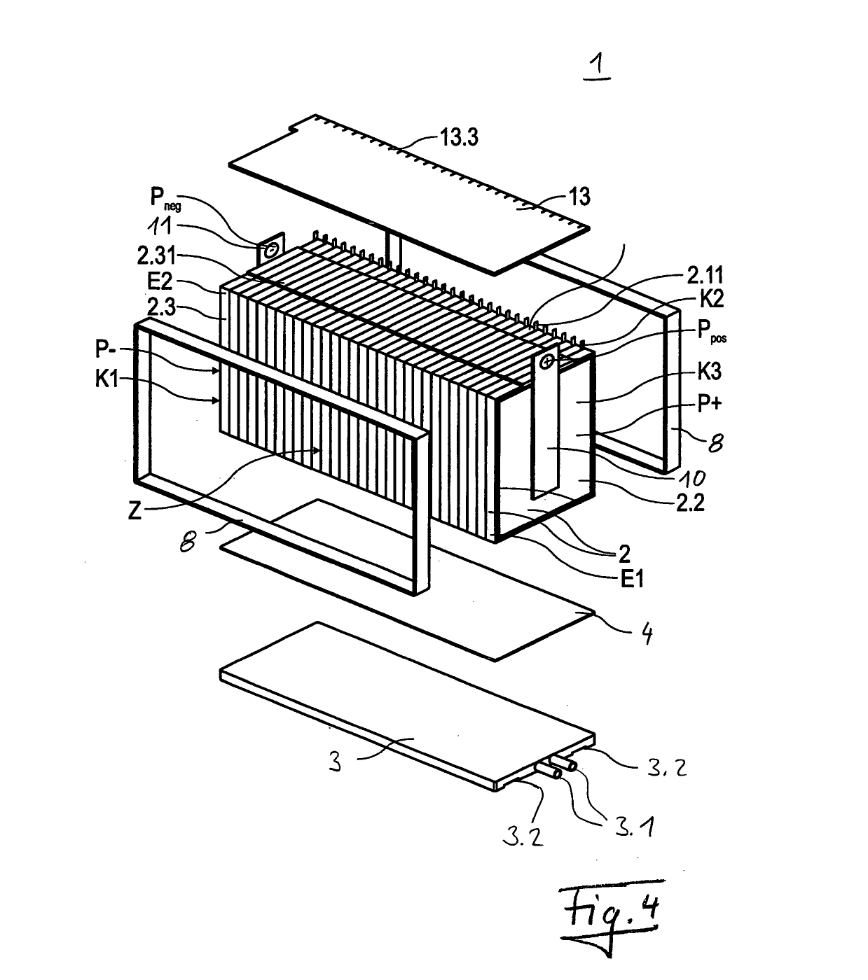

FIG. 4 shows a battery with a plurality of frame flat cells in a schematic spatial exploded illustration;

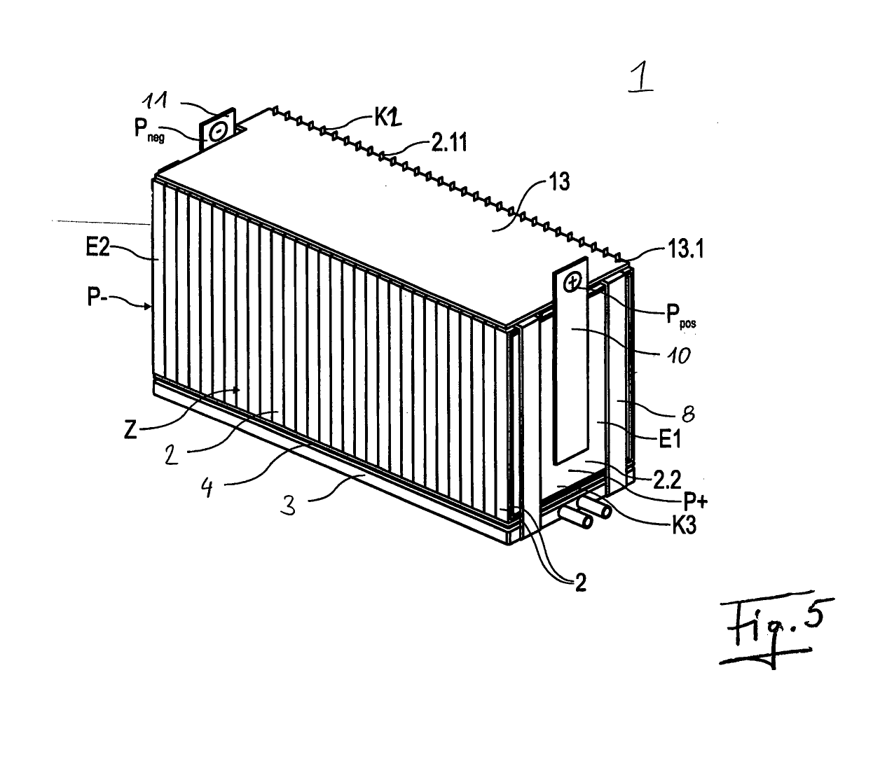

FIG. 5 shows a schematic spatial view of the battery according to FIG. 4 in an assembled state;

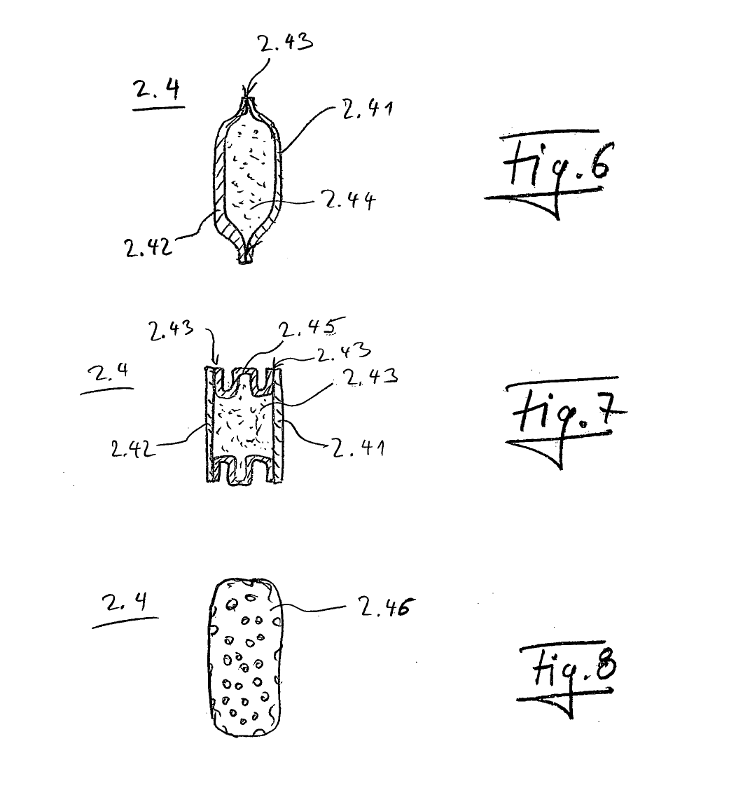

FIG. 6 shows a schematic cross-sectional view of a damping element;

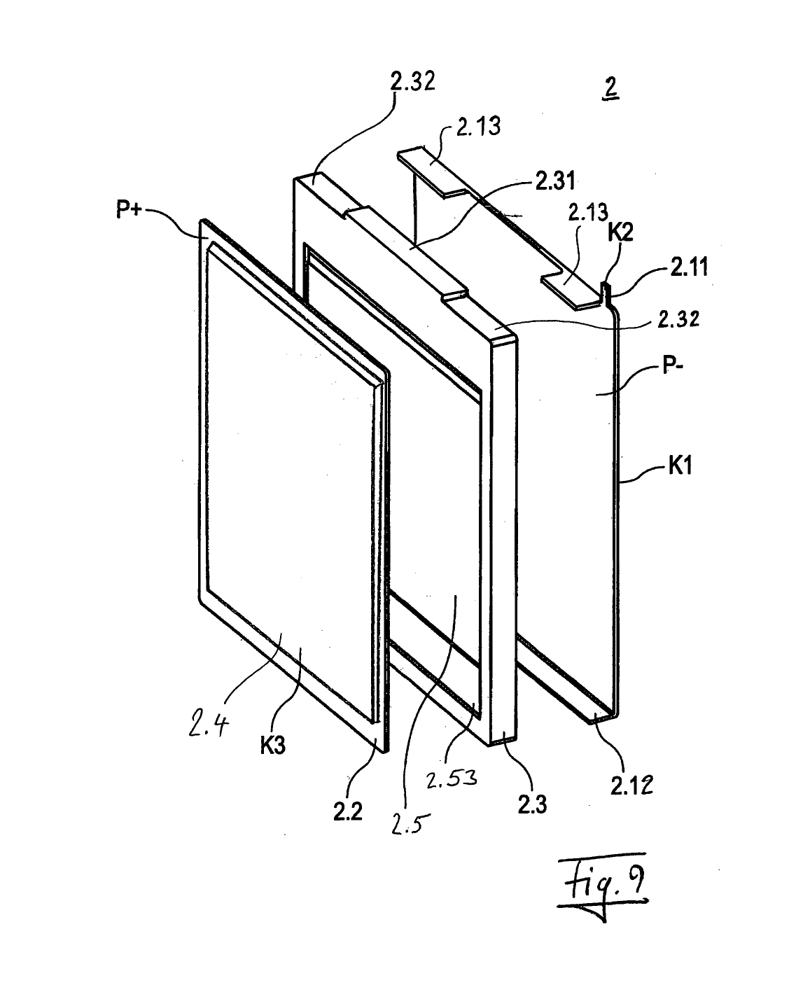

FIG. 7 shows a schematic cross-sectional view of a different damping element;

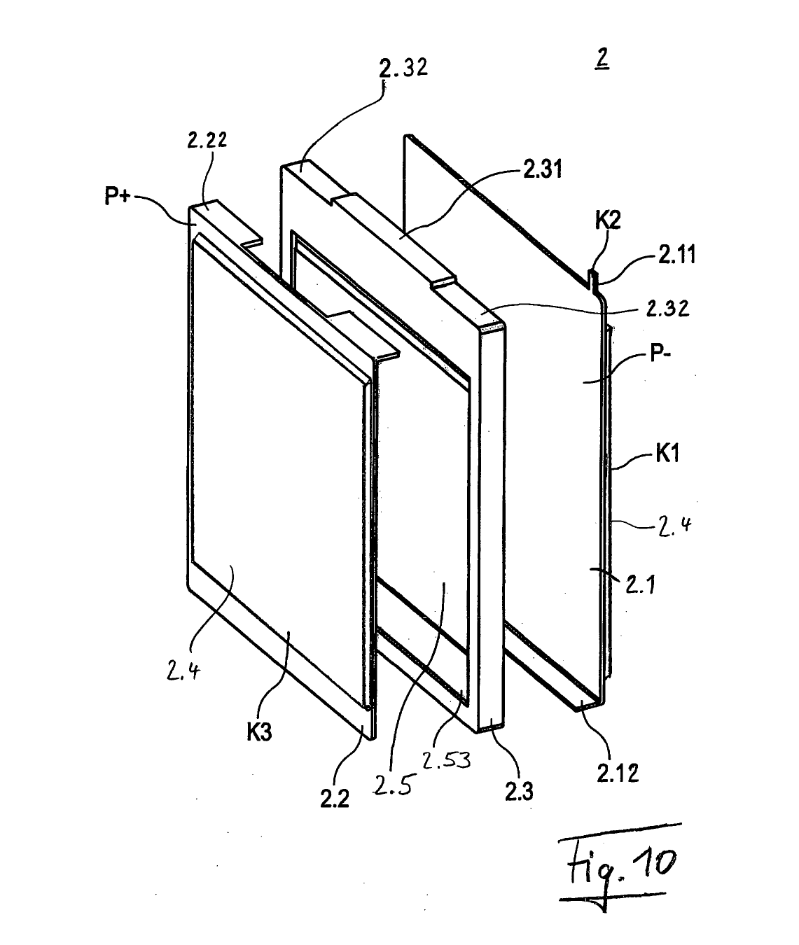

FIG. 8 shows a schematic cross-sectional view of a further damping element;

FIG. 9 shows a different frame flat cell in a schematic spatial exploded illustration;

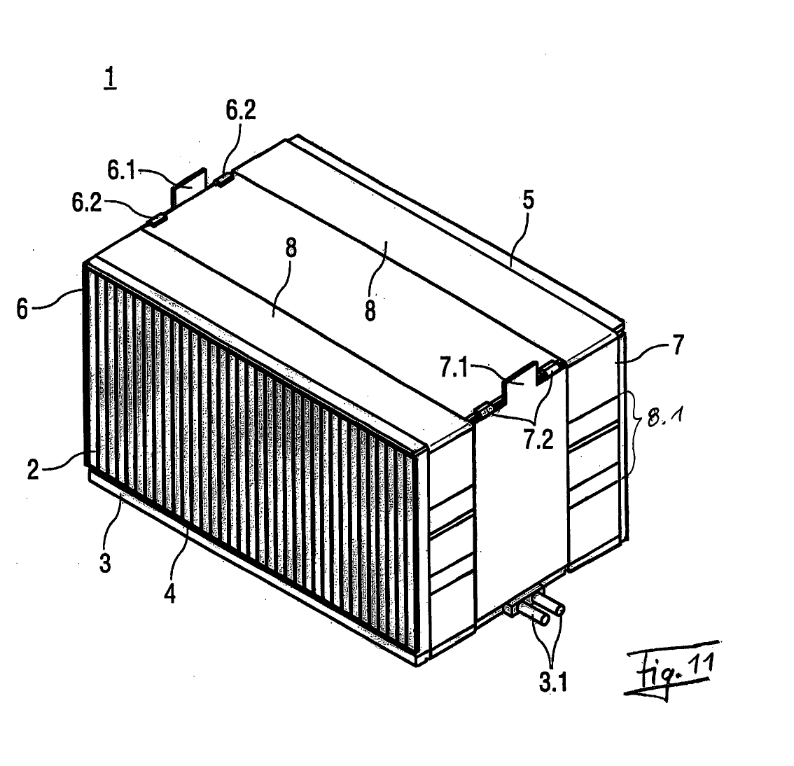

FIG. 10 shows a similar frame flat cell in a schematic spatial exploded illustration;

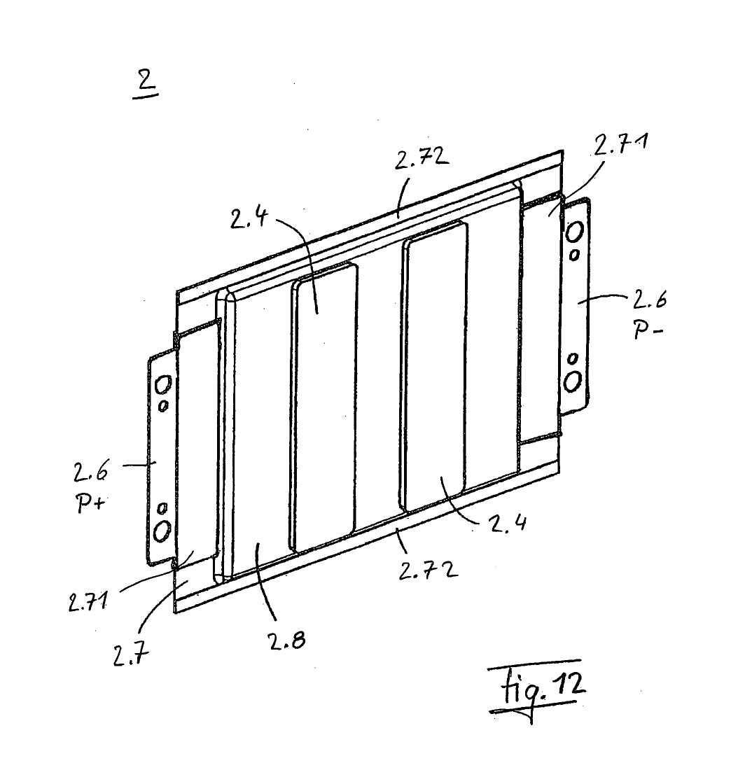

FIG. 11 shows a further battery with frame flat cells in a schematic spatial view;

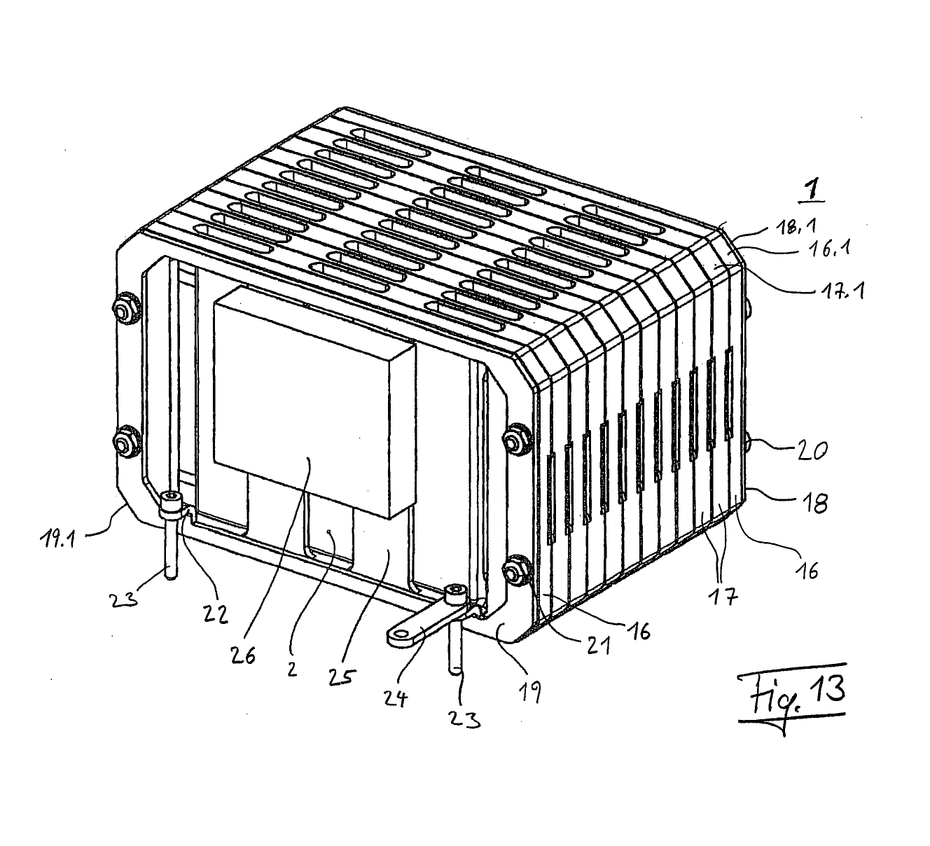

FIG. 12 shows a pouch cell with damping elements in a schematic spatial view;

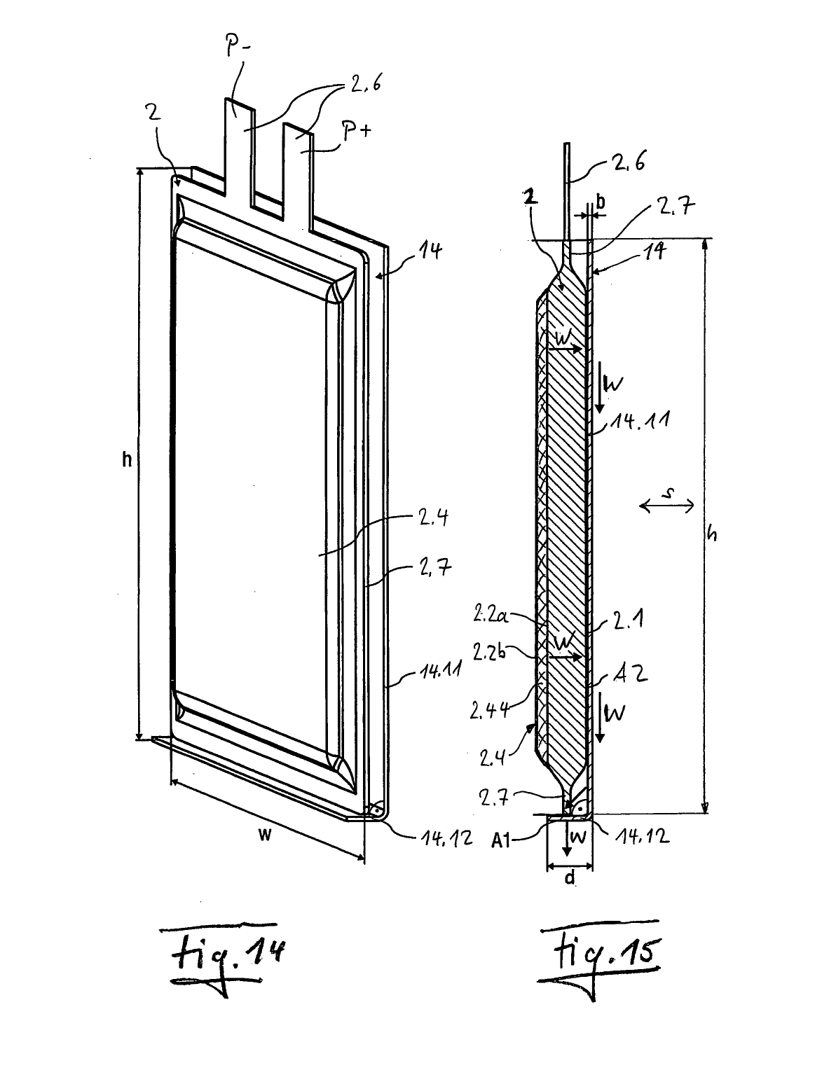

FIG. 13 shows a battery with a plurality of pouch cells which are clamped by means of tie bolts between frame elements in a schematic spatial view;

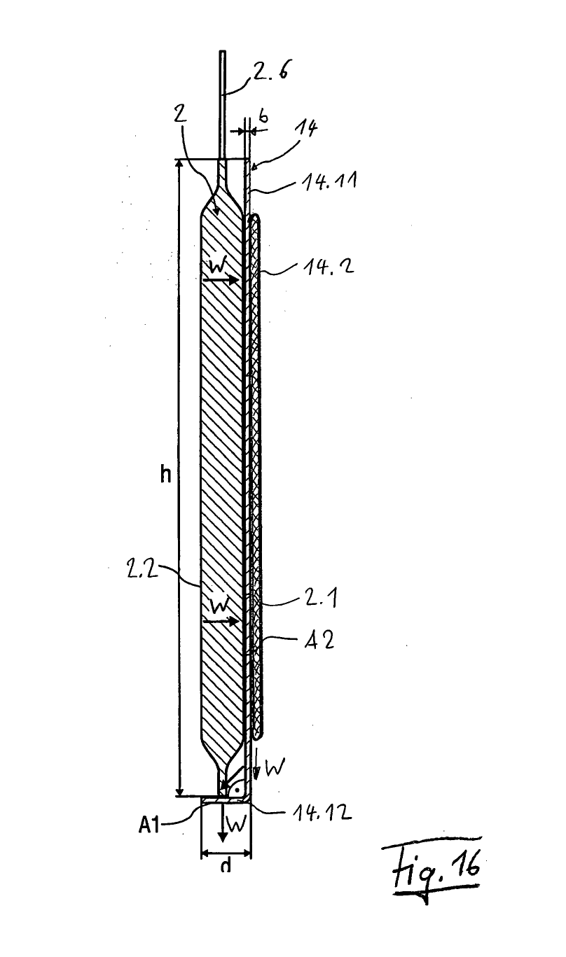

FIG. 14 shows an individual cell and a heat-conducting element in a schematic spatial view,

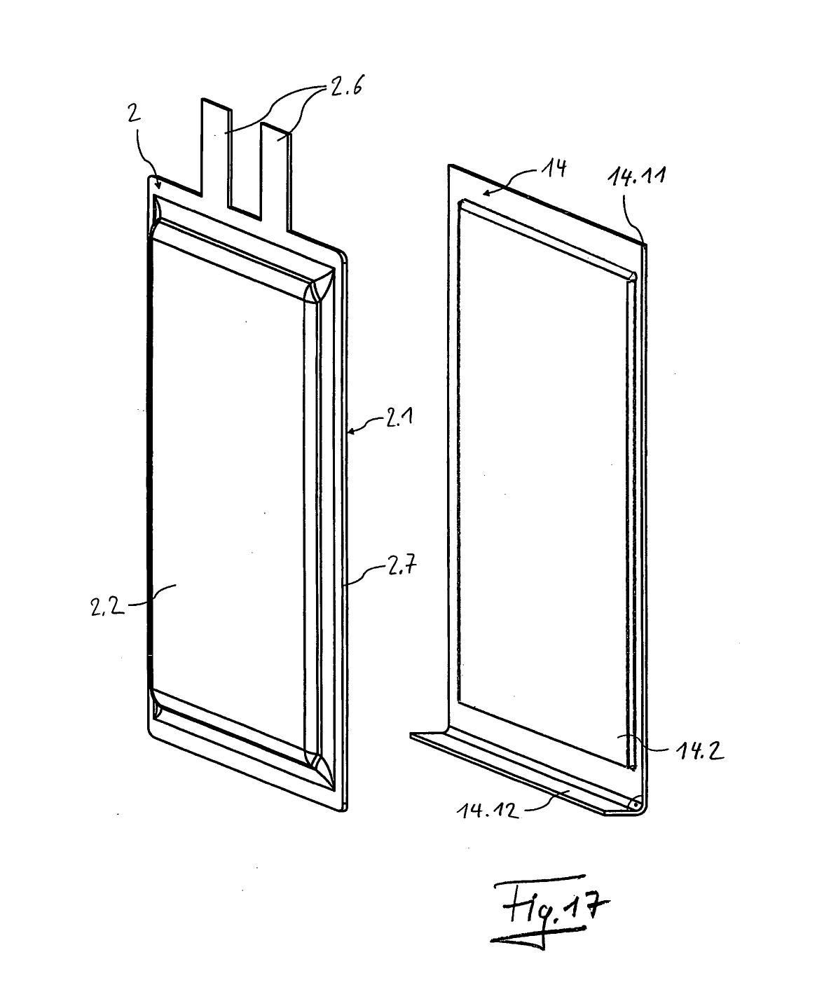

FIG. 15 shows an individual cell and a heat-conducting element in a schematic cross-sectional view,

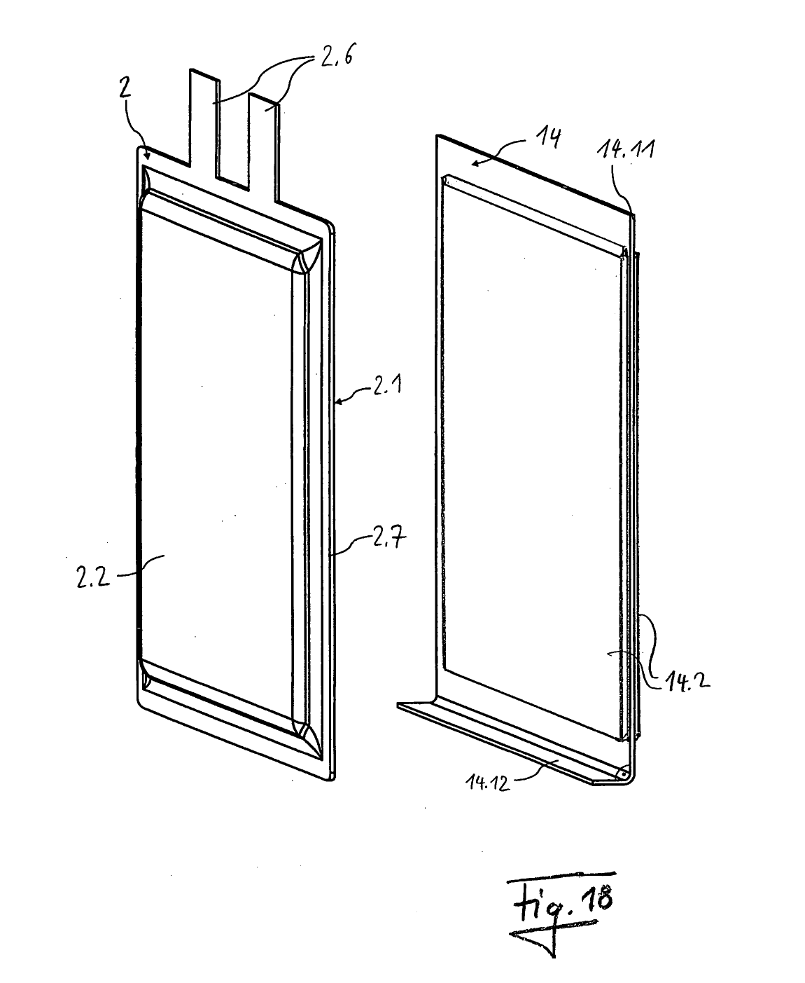

FIG. 16 shows an individual cell and a heat-conducting element in a schematic cross-sectional view,

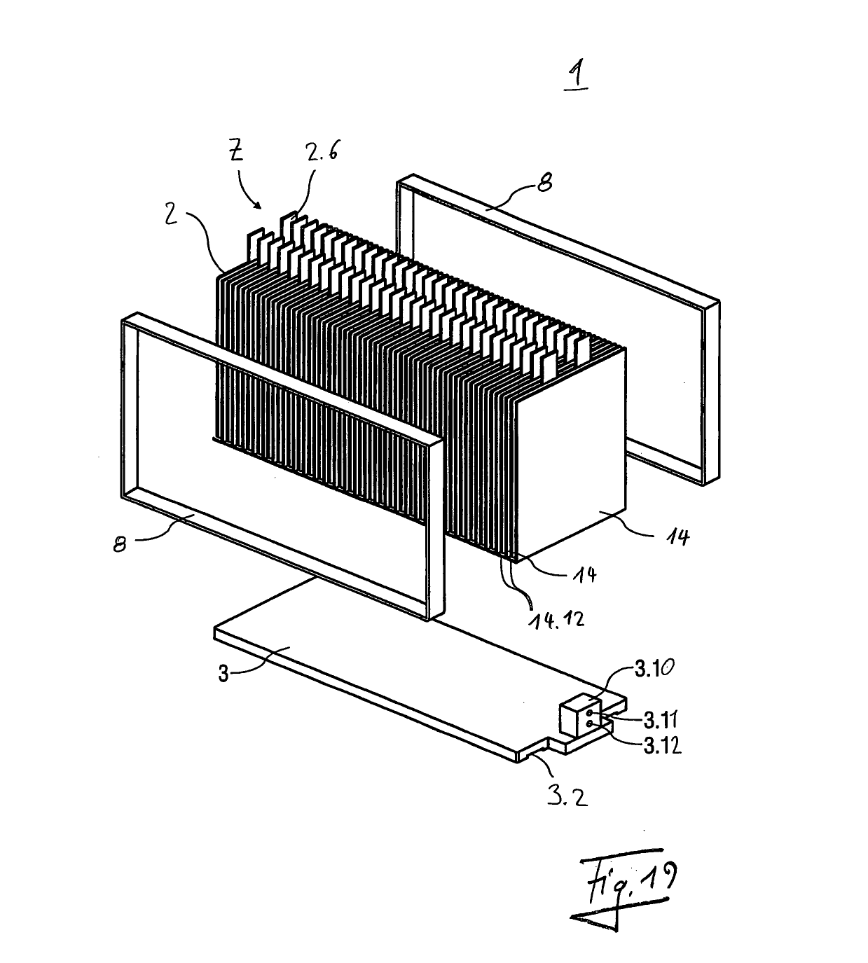

FIG. 17 shows an individual cell and a heat-conducting element in a schematic perspective exploded illustration,

FIG. 18 shows an individual cell and a heat-conducting element in a schematic perspective exploded illustration,

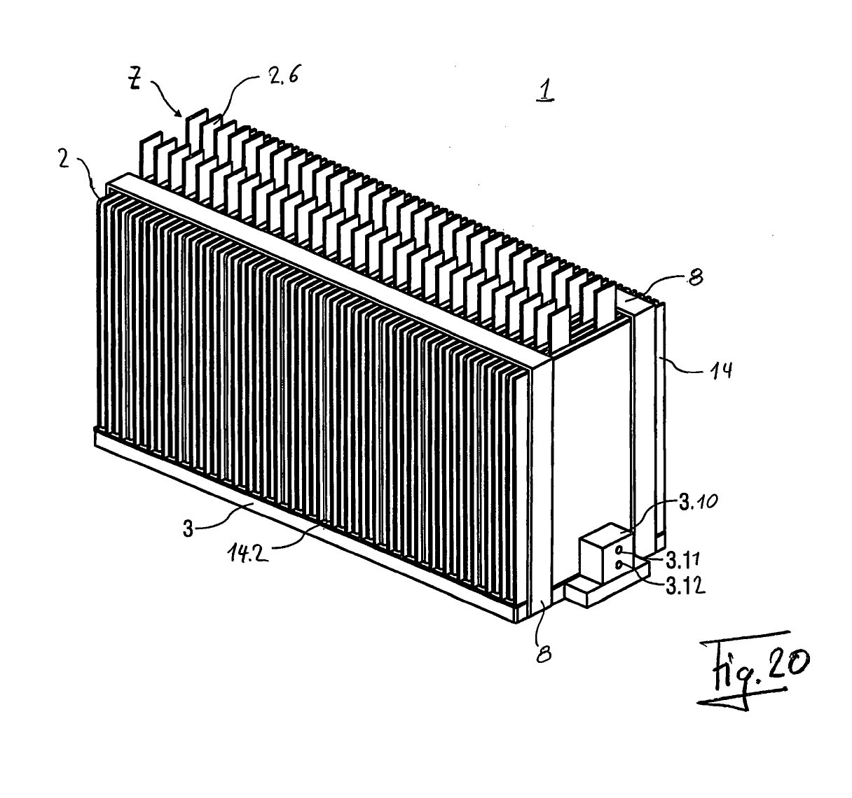

FIG. 19 shows a battery in a schematic spatial exploded illustration,

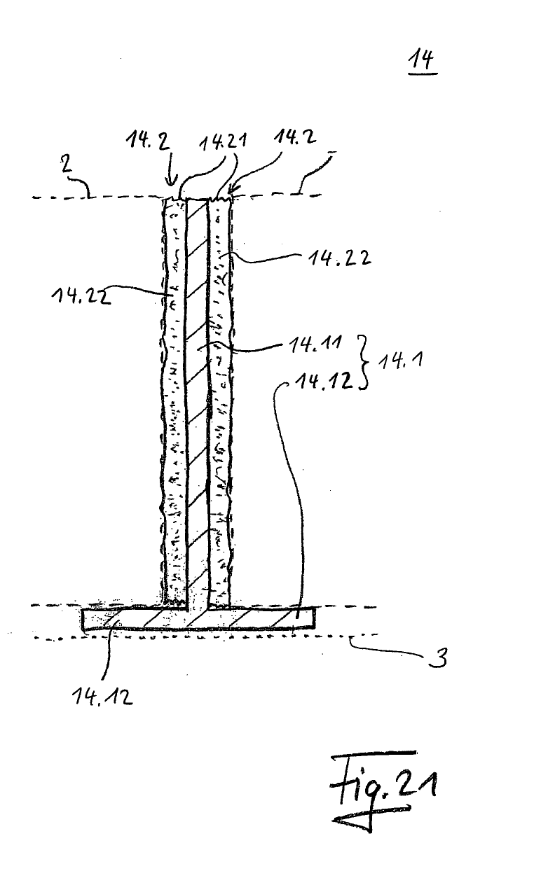

FIG. 20 shows an installed battery in a schematic spatial view,

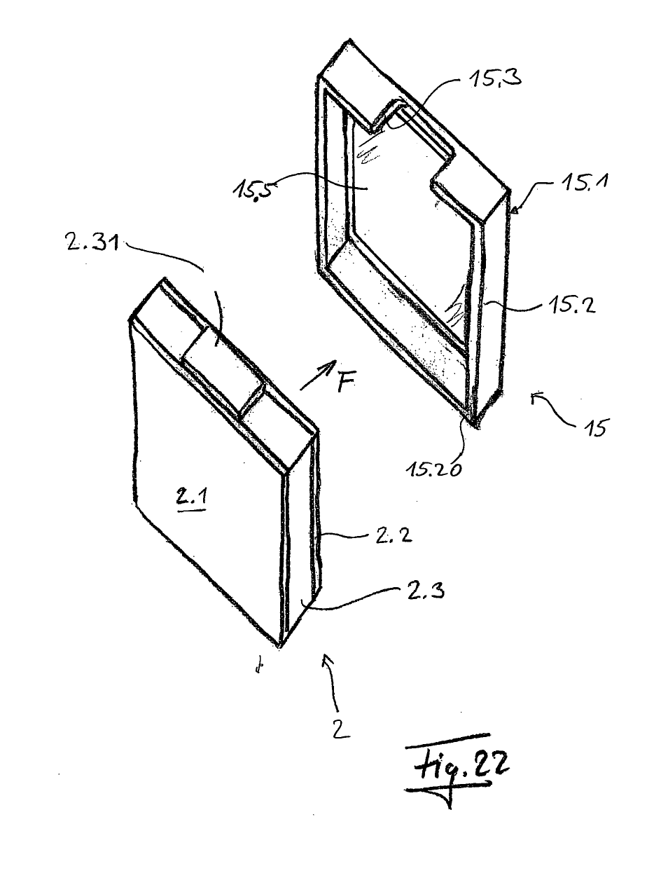

FIG. 21 shows a heat-conducting element in a schematic cross-sectional view;

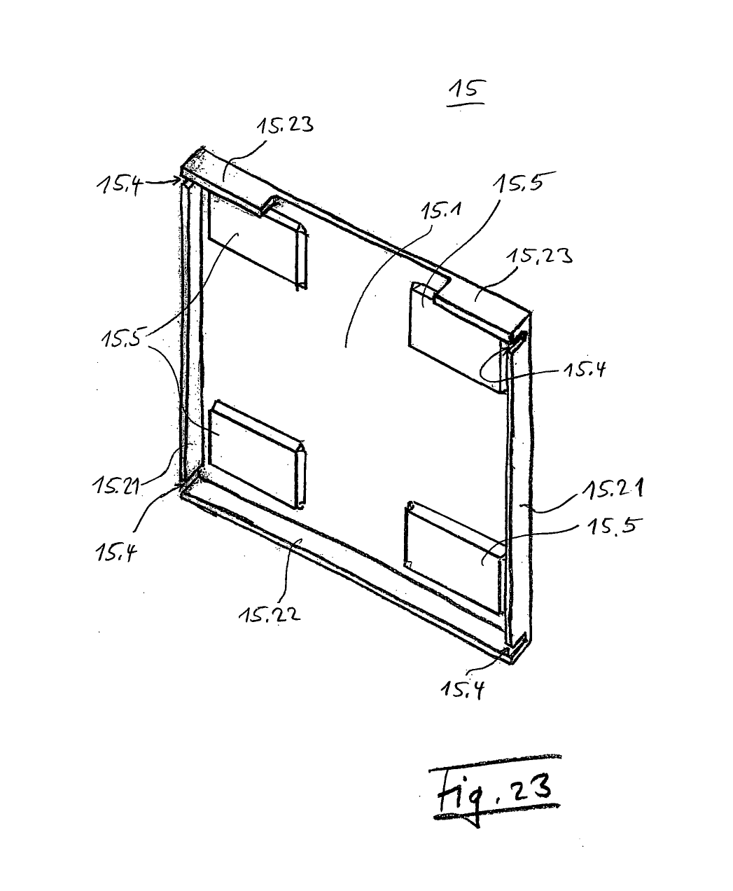

FIG. 22 shows a heat-conducting element with frame flat cells in a schematic spatial view;

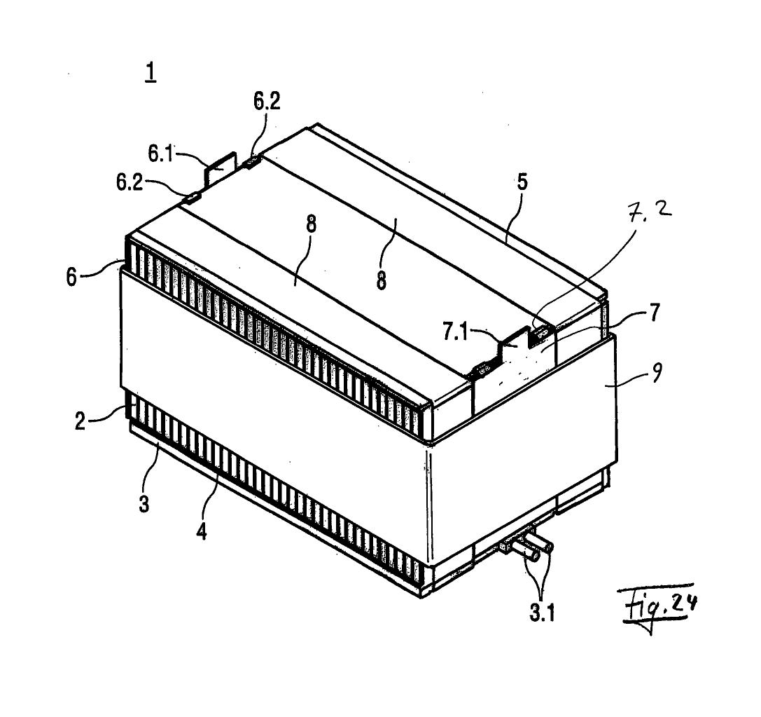

FIG. 23 shows a similar heat-conducting element in a schematic spatial view;

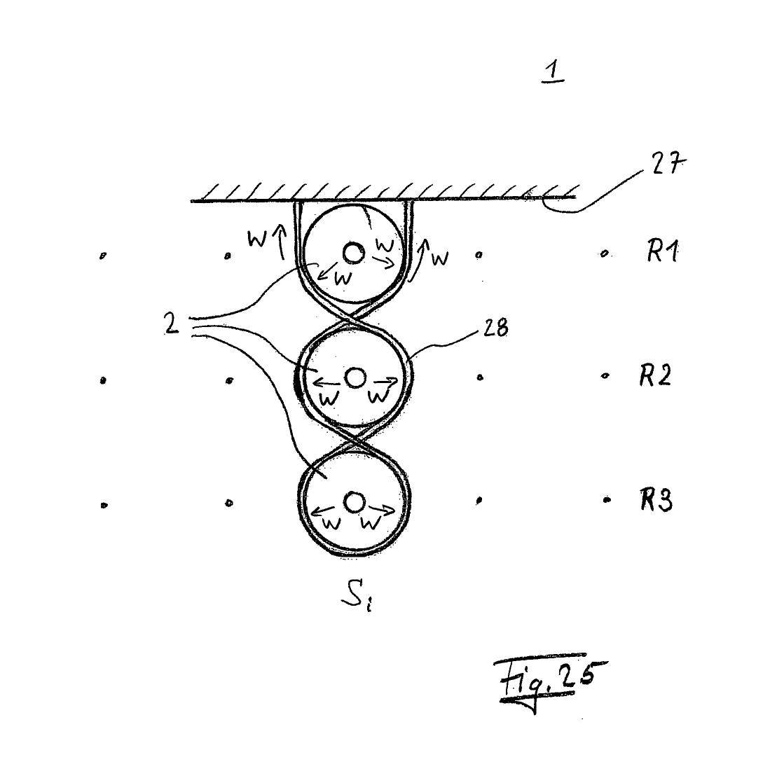

FIG. 24 shows a battery with a cell block made up of a plurality of frame flat cells clamped in three directions in a schematic spatial view;

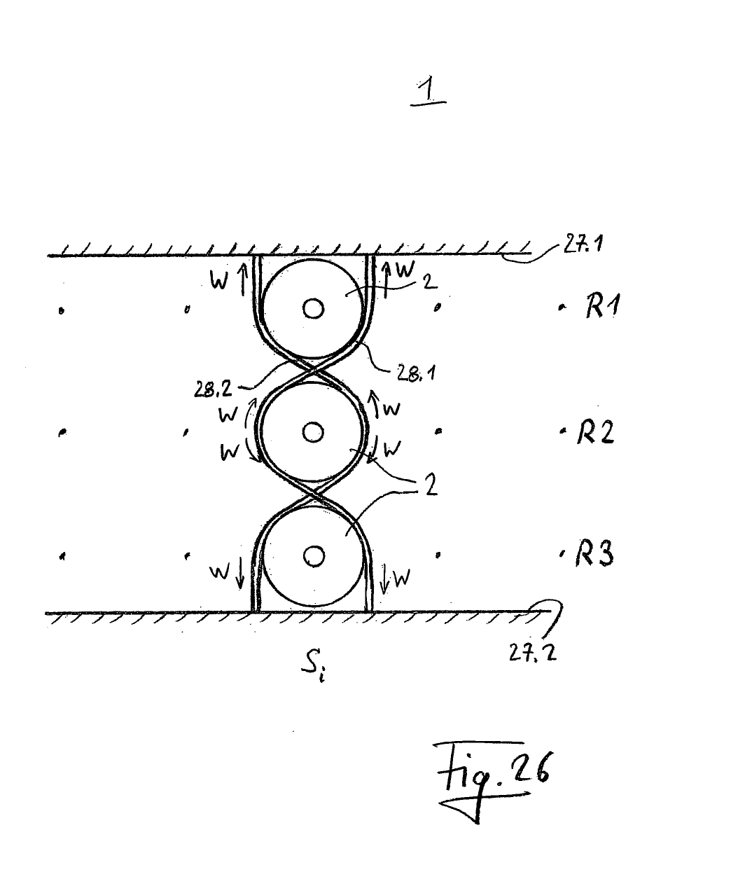

FIG. 25 shows a battery with a plurality of rows of cylindrical battery cells, which are clamped by means of a fixing strap to a battery housing wall, in a schematic plan view;

FIG. 26 shows a battery with a plurality of rows of cylindrical battery cells, which are clamped by means of fixing straps between two battery housing walls, in a schematic plan view.

It is to be pointed out that the illustrations in the figures are schematic and are at least substantially limited to the reproduction of features which are helpful for the understanding of the invention. It is also to be pointed out that the dimensions and size ratios reproduced in the figures are essentially based on the clarity of the illustration and are not necessarily to be understood as limiting unless something else should emerge from the description.

Parts which correspond to one another are provided with the same reference numbers in all figures.

FIG. 1 and FIG. 2 show a galvanic cell 2 constructed as a flat cell (also termed individual cell 2 or cell 2). In this case, a cell housing of the individual cell 2 is formed from two cell housing side walls 2.1, 2.2 and a cell housing frame 2.3 arranged therebetween, which runs around the boundary.

The cell housing side walls 2.1, 2.2 of the individual cell 2 are electrically conductively realised and form poles P+, P− of the individual cell 2.

Two damping elements 2.4 are arranged on the cell housing side wall 2.1 of the negative pole P−. The damping elements 2.4 are constructed with elastically resilient properties. Additionally, the damping elements 2.4 are electrically conductively constructed and have good heat conduction properties. The damping elements 2.4 are adhesively bonded to the cell housing side wall 2.1, wherein the adhesive bonding is realised in a heat-conducting or heat permeable manner.

The individual cell 2 has at least three voltage connection contacts K1 to K3. Specifically, the cell housing side wall 2.1 forming the pole P− has at least two voltage connection contacts K1, K2 which are electrically connected to one another, connected in parallel in particular, inside the cell in particular. In this case, the first voltage connection contacts K1 are formed by the damping elements 2.4 electrically conductively attached to the pole P− of the individual cell 2 and thus the cell housing side wall 2.1. The second voltage connection contact K2 is realised as a measuring connection 2.11, which protrudes radially above the cell housing side wall 2.1 at any desired position, here on the upper side of the cell 2, above the individual cell 2 as a lug-like extension.

The third voltage connection contact K3 is formed by the cell housing side wall 2.2 forming the pole P+.

The cell housing frame 2.3 is realised in an electrically insulating manner, so that the cell housing side walls 2.1, 2.2 of different polarity are electrically insulated from one another. The cell housing frame 2.3 additionally has a partial material elevation 2.31 on an upper side, the function of which is explained in more detail in the description of FIG. 4 and FIG. 5.

FIG. 2 shows the individual cell 2 according to FIG. 1 in a cross-sectional view, wherein an electrode stack 2.5 is arranged in the cell housing 2.

In a central region, electrode films 2.51 of different polarity, particularly aluminium- and/or copper films and/or plastic films made up of a metal alloy are stacked one above the other and electrically insulated from one another by means of a separator (not illustrated in any more detail), particularly a separator film.

In a boundary region of the electrode films 2.51 protruding over the central region of the electrode stack 2.5, electrode films 2.51 of the same polarity are electrically connected to one another. The ends of the electrode films 2.51 of the same time polarity which are connected to one another thus form a pole contact 2.52. The pole contacts 2.52 of different polarity of the individual cell 2.2 are also termed current contact lugs 2.52 in the following. In detail, the ends of the electrode films 2.51 are electrically conductively compression moulded and/or welded to one another and form the current contact lugs 2.52 of the electrode stack 4.

The electrode stack 2.5 is arranged in the cell housing frame 2.3 running around the boundary of the 2.5. The cell housing frame 2.3 has to this end two mutually spaced material recesses 2.33, 2.34 which are constructed in such a manner that the current contact lugs 2.52 of different polarity are arranged in the material recesses 2.33, 2.34. The clearance h1 of the material recesses 2.33, 2.34 is constructed in such a manner that it corresponds to the extent of the current contact lugs 2.52 stacked one above the other in an uninfluenced manner or is lower than the same. The depth t of the material recesses 2.33, 2.34 corresponds to the extent of the current contact lugs 2.52 or is constructed larger than the same.

As the cell housing frame 2.3 is preferably produced from an electrically insulating material, the current contact lugs 7 of different polarity are electrically insulated from one another, so that additional arrangements for an electrical insulation are not necessary.

In the case of fixing the cell housing side walls 2.1, 2.2, which for example takes place in a manner which is not illustrated in any more detail by means of adhesive bonding and/or flanging the flat sides 2.8 in a recess running around in the cell housing frame 2.3, the current contact lugs 2.52 of different polarity are pressed against the cell housing side walls 2.1, 2.2, so that a respective electric potential of the current contact lugs 2.52 is present at the cell housing side walls 2.1, 2.2 and these form the poles P+, P− of the individual cell 2.

In an advancement of the invention, a film, which is not illustrated in any more detail and e.g. is produced from nickel, can additionally be arranged between the current contact lugs 2.52, which e.g. are produced from copper produced, and the housing side walls 2.1, 2.2, which e.g. are produced from aluminium, in order to achieve an improved electrical connection between the current contact lugs 2.52 and the cell housing side walls 2.1, 2.2.

In an embodiment of the invention, it is furthermore possible to arrange an electrically insulating film, which is not illustrated in any more detail, between the current contact lugs 2.52 and the cell housing side walls 2.1, 2.2 or to realise the cell housing side walls 2.1, 2.2 with an electrically insulating layer on one side, so that an electrical contacting of the current contact lugs 2.52 with the cell housing side walls 2.1, 2.2 only arises during a full penetration welding method from outside through the cell housing side walls 2.1, 2.2, which is not described in any more detail and is known from the prior art.

According to the illustration in FIG. 2, the damping elements 2.4 are arranged approximately at the same time height as the current contact lugs 2.52 on the housing side wall 2.1 and, measured from the housing side wall 2.1, have a height h2. The part of the flat side 2.8 of the cell 2 or the housing side wall 2.1, which delimits the electrode stack 2.5 is free of damping elements 2.4. If a compressive force D is exerted onto the individual cell 2 during the lining up and clamping of a plurality of individual cells 2 in the direction of a cell stack (stack direction s), the introduction of the compressive force D is restricted to the current contact lugs 2.52 and the adjacent regions of the cell housing frame 2.3, whilst the electrode stack 2.5 remains free of compressive forces. This also remains so if the electrode stack 2.5 should expand in the stack direction s during the operation of the individual cell 2.

FIG. 3 illustrates an exploded illustration of the individual cell 2 explained in more detail in FIG. 1 and FIG. 2 and also shows the arrangement of the electrode stack 2.5 in the cell housing frame 2.3 and also the cell housing side walls 2.1, 2.2.

In this case, the cell housing side wall 2.1 with the lug-like measuring connection 2.11 is bent in a lower region through 90° in the direction of the cell housing frame 2.3, in order to construct a folded edge 2.12, so that in the case of use of a heat-conducting plate 4 illustrated in FIG. 4 and FIG. 5, an enlargement of an effective heat transfer surface A1 and thus an improved cooling of the battery 1 are achieved.

In modifications of this exemplary embodiment, the damping elements are 2.4 are arranged on the other housing side wall 2.2 or on both housing side walls 2.1, 2.2. In the latter modification, provision can be made as a further design variant for a damping element 2.4 to be arranged in the upper region of the housing side wall 2.1 and a further damping element 2.4 in the lower region of the housing side wall 2.2 or vice versa. An arrangement of this type can, particularly if the measuring connection 2.11 is absent, prevent an undesired polarity reversal of the cells, as the pole position is encoded by the position of the damping elements 2.4.

Illustrated in an exploded illustration and in a perspective view in FIG. 4 and FIG. 5 is the battery 1, which is used for example in a vehicle, particularly a hybrid- and/or pilot vehicle.

FIG. 4 shows an exploded illustration of a battery 1 with a cell composite Z made up of a plurality individual cells 2. For forming the cell composite Z, the poles P+, P− of a plurality of individual cells 2 are electrically connected to one another in series and/or in parallel as a function of a desired electric voltage and power of the battery 1. Likewise as a function of the desired electric voltage and power of the battery 1, the cell composite Z can be formed from any desired number of individual cells 2 in advancements of the invention.

Due to the electrical contacting of the cell housing side walls 2.1, 2.2 of adjacent individual cells 2 with different electric potential in each case via the damping elements 2.4, a serial electrical connection of the poles P+, P− of the individual cells 2 is realised. In this case, the cell housing side wall 2.2 of one of the individual cells 2 in particular adjoins the damping elements 2.4 of an adjacent individual cell 2, which is attached to the cell housing side wall 2.1 using the lug-like measuring connection 2.11, in a non-positive fitting, positive fitting and/or materially connected manner and is in this manner electrically connected to the adjacent individual cell 2, as the damping elements 2.4 are electrically conductive.

In the exemplary embodiment of the invention illustrated, the battery 1 is formed from thirty individual cells 2 which are electrically connected to one another in series. For drawing and/or supplying electrical energy from and/or to the battery 1, an electrical connection element 10 is arranged on the cell housing side wall 2.2 of the first individual cell E1 of the cell composite Z, which in particular forms the positive pole P+ of the first individual cell E1. This connection element 10 is realised as an electrical connection lug and forms the positive pole connection Ppos of the battery 1.

An electrical connection element 11 is also arranged on the cell housing side wall 2.1 of the last individual cell E2 of the cell composite Z, which in particular forms the negative pole P− of the latter individual cell E2. This connection element 11 is likewise realised as an electrical connection lug and forms the negative pole connection P_{neg} of the battery 1. It may be noted that at this point at least the upper damping element 2.4 of the latter individual cell E2 is removed.

The cell composite Z is thermally coupled to the heat-conducting plate 3 on the underside of the battery 1. The heat-conducting plate has heat transfer agent connections 3.1, which are connected to a for example meandering and if appropriate branched heat transfer agent channel (not illustrated in any more detail) arranged in the interior of the heat-conducting plate 3. In this case, the cell housing side walls 2.1 are thermally coupled to the heat-conducting plate 3 directly or indirectly via a heat-conductive material, particularly a heat-conducting film 4, using the folded edge 2.12 bent through 90° in the direction of the cell housing frame 2.3, so that an effective cooling of the battery 1 is achieved.

In an advancement of the invention, the heat conductive material can additionally or alternatively be formed from a casting compound and/or a paint.

For a non-positive fitting connection of the individual cells 2 to the cell composite Z and a positive fitting connection of the heat-conducting plate 3 and the heat-conducting film 4 to the cell composite Z, the cell composite Z, the heat-conducting plate 3 and the heat-conducting film 4 are arranged in a housing frame. This housing frame is formed in particular from one or a plurality of clamping elements 8, e.g. clamping straps, surrounding the cell composite Z completely, which clamping elements connect the individual cells 2 or the cell composite Z, the heat-conducting plate 3 and the heat-conducting film 4 in a non-positive fitting manner both in the horizontal and in the vertical direction. In order to enable a secure holding of the clamping elements 8, material depressions 3.2 preferably corresponding to the dimensions of the clamping elements 8 are constructed on an underside of the heat-conducting plate 3.

In advancements of the invention, which are not illustrated in any more detail, a few or all components, i.e. the individual cells 2, the heat-conducting plate 8, the heat-conducting film 11 or the entire battery 1, can alternatively or additionally be fitted in a battery housing in a partially or completely encapsulated manner.

In this exemplary embodiment of the invention, the damping elements 2.4 are constructed in an elastically resilient, electrically conductive and heat conducting manner. Thus, the housing side walls 2.1 and 2.2, which form the poles P− and P+ of the cells 2, can reliably be electrically contacted between adjacent cells via the damping elements 2.4. Further, a compressive force, which is introduced into the cell block Z via the clamping straps 8, is introduced via the damping elements 2.4 into the frame region of the cells 2, wherein the region of the electrode stack 2.5 remains free of clamping forces. The cell 2, particularly the electrode stack 2.5 can extend comparatively freely in the stack direction during operation. Vibrations can also be absorbed in the damping elements 2.4, wherein the individual cells 2 are substantially mechanically decoupled from one another. Finally, the damping elements 2.4 have good heat conduction properties. A heat exchange can thereby take place between adjacent individual cells 2. Excess heat of an individual cell 2 can be dissipated not only via the cell housing side wall 2.1 of this individual cell 2, but additionally via the cell housing side wall 2.1 of an adjacent individual cell 2.

If the battery 1 is for example a lithium ion high voltage battery, special electronics are generally required, which e.g. monitor and correct a cell voltage of the individual cells 2, a battery management system, which in particular controls a power consumption and emission of the battery 1 (=battery control), and safety elements, which in the event of malfunctions of the battery 1, carry out a safe separation of the battery 1 from an electrical network.

In the exemplary embodiment of the invention illustrated, an electronic component 13 is provided, which at least contains devices for cell voltage monitoring and/or for cell voltage compensation, which are not illustrated in any more detail. The electronic component 13 can also be constructed as an encapsulated electronic module in an advancement of the invention.

The electronic component 13 is arranged at the head side on the cell composite on the clamping elements 12 and the cell housing frame 2.3 of the individual cells 2. In order to achieve a bearing surface of the electronic component 13 and a fixing of the clamping elements 8 on the upper side of the cell composite Z at the same time, the material elevation 2.31 is constructed partially on the upper side of the frame 2.3 of each individual cell 2, the height of which corresponds in particular to the thickness of the clamping element 8. Non-positive fitting, positive fitting and/or materially connected connection technologies, which are not illustrated in any more detail, are used for fixing the electronic component 13 on the cell composite Z and/or on the clamping elements 8.

For an electrical contact of the cell composite Z with the electronic component 13, the lug-like measuring connections 2.11 arranged on the cell housing side walls 2.1 are guided through contact elements 13.3 arranged in the electronic component 13, which have a shape corresponding to the lug-like measuring connections 2.11.

Additionally, further electronic modules, which are not illustrated, are also provided, which for example contain the battery management system, the battery control, the safety elements and/or further devices for operating and for controlling the battery 1.

FIG. 6 shows a structure of a damping element 2.4 illustrated in FIG. 1, FIG. 2 or FIG. 3 in a first preferred design variant in a schematised cross-sectional view.

According to the illustration in FIG. 6, the damping element 2.4 has a first envelope 2.41 and a second envelope 2.42. The envelopes 2.41, 2.42 are connected to one another at a seam 2.43, for example by means of welding or the like. The envelopes 2.41, 2.42 are produced from an electrically conductive and heat conductive material, such as for example aluminium or the like. The envelopes 2.41, 2.42 enclose an interior 2.44 which in the design variant illustrated is filled with an insulating material, such as for example a PU foam, foam rubber, felt or the like. It is also conceivable in a further design variant to only fill the interior 2.44 with air.

FIG. 7 shows a structure of a damping element 2.4 illustrated in FIG. 1, FIG. 2 or FIG. 3 in a different preferred design variant in a schematised cross-sectional view.

According to the illustration in FIG. 7, the damping element 2.4 has a first envelope 2.41 and a second envelope 2.42. A bellows structure 2.45 extends at the boundary between the envelopes 2.41, 2.42, which is connected to seams 2.43 on the envelopes 2.41, 2.42. The envelopes 2.41, 2.42 are produced from an electrically conductive and heat conductive material, such as for example aluminium or the like. The envelopes 2.41, 2.42 enclose an interior 2.44 which in the design variant illustrated is filled with an insulating material, such as for example a PU foam, foam rubber, felt or the like. In the case of a corresponding rigidity of the bellows structure 2.45, it is also conceivable in a further design variant to only fill the interior 2.44 with air.

FIG. 8 shows a structure of a damping element 2.4 illustrated in FIG. 1, FIG. 2 or FIG. 3 in a further preferred design variant in a schematised cross-sectional view.

According to the illustration in FIG. 8, the damping element 2.4 has a foam block 2.45. The foam block 2.45 has a heat-conductive and electrically conductive plastic. In a further design variant, the foam block 2.45 is foamed from an inherently electrically and thermally insulating material which is doped with fillers which are good electrical and thermal conductors.

Reference may in particular, again but not only be made with reference to FIG. 6 to FIG. 8 to the fact that the relations of dimensions of components, such as component sizes or component thicknesses, may be illustrated in a misrepresented manner in the figures for clarifying the illustration and may deviate from actual realisations markedly if necessary.

FIG. 9 shows an individual cell 2 constructed as a flat cell as a further exemplary embodiment of the present invention in a schematised spatial exploded illustration. This exemplary embodiment is a modification of the exemplary embodiment illustrated in FIG. 1 to FIG. 5; as long as nothing different emerges from the following explanations, the explanations made with reference to FIG. 1 to FIG. 5 are to be applied correspondingly.

According to the illustration in FIG. 9, a cell housing (a housing) of the cell 2 is formed from two cell housing side walls 2.1, 2.2 and a cell housing frame 2.3 arranged therebetween, which runs around the boundary. The cell housing side walls 2.1, 2.2 of the cell 2 are electrically conductively realised and form poles P+, P− of the cell 2. The cell housing frame 2.3 is realised in an electrically insulating manner, so that the cell housing side walls 2.1, 2.2 of different polarity are electrically insulated from one another. The cell housing frame 2.3 additionally has a partial material elevation 2.31 on an upper side.

As in the case of the previous exemplary embodiment of the invention, the cell housing side wall 2.1 with the lug-like measuring connection 2.11 also has a folded edge 2.12 bent through 90° in the direction of the cell housing frame 2.3 in a lower region. Further, this cell housing side wall 2.1 has tabs 2.13 bent through 90° in the direction of the cell housing frame 2.3 in an upper region. In assembly, the tabs 2.13 grip next to the material elevation 2.31 onto the upper narrow side 2.32 of the cell housing frame 2.3, whilst the edge 2.12 grips onto the lower narrow side of the cell housing frame 2.3.

In the present exemplary embodiment, the cell housing side wall 2.2 used as positive pole P+ has a damping element 2.4 which is lifted from the cell housing side wall 2.2. Thus, the damping element 2.4 here forms the third voltage connection contact K3 of the cell 2, whilst the other cell housing side wall 2.1 forms the first voltage connection contact K1. With respect to the properties of the damping element 2.4, reference may be made to the explanations of the previous exemplary embodiment and the modifications thereof. In this exemplary embodiment, the damping element 2.4 extends as far as a small boundary region above the entire surface of the cell housing side wall 2.2, which enables a distribution of compressive forces onto the entire surface of the cell housing side walls 2.1, 2.2 of the cell 2. In design variants, the damping element 2.4 may be constructed on the cell housing side wall 2.2 only in certain sections.

FIG. 10 shows a modification of the cell 2 illustrated in FIG. 9 in a schematised spatial exploded illustration. The cell housing side wall 2.1 with the lug-like measuring connection 2.11 has a lower edge (folded edge) 2.12 bent through 90° in the direction of the cell housing frame 2.3 in a lower region. In this modification, the other cell housing side wall 2.2 has tabs 2.22 bent through 90° in the direction of the cell housing frame 2.3 in an upper region. In assembly, the tabs 2.22 of the second housing side wall 2.2 grip next to the material elevation 2.31 onto the upper narrow side 2.32 of the cell housing frame 2.3, whilst the edge 2.12 of the first housing side wall 2.1 grips onto the lower narrow side of the cell housing frame 2.3.

According to the illustration in FIG. 10, the second cell housing wall 2.2 has a damping element 2.4 and additionally, the first cell housing wall 2.1 has a damping element 2.4. Both damping elements 2.4 are constructed like the damping element 2.4 of the exemplary embodiment shown in FIG. 8 and form the first and the third voltage connection contact K1, K3 of the cell 2.

A construction of the cell 2 according to FIG. 9 or FIG. 10 is advantageous in the case of a battery which is described as a modification of the battery 1 shown in FIG. 4 and FIG. 5. In this case, the clamping straps 8 are produced from a heat-conducting material such as for example metal and bear planarly against the upper narrow sides 2.32 of the cells 2 and thus against the tabs 2.13 of the cell housing side wall 2.1. As a result, a heat transfer between the tabs 2.13 of the cell housing side wall 2.1 to the clamping straps 8 can take place, and the excess heat can be transported through the clamping straps 8, if necessary as far as the cooling plate 3.

By means of an electrically insulating, but heat-conductive or heat permeable coating of the clamping straps or a corresponding intermediate layer between the clamping straps 8 and the tabs 2.13 of the cell housing side wall 2.1 (not illustrated in any more detail), a short circuit or an undesired contact between adjacent cells 2 is prevented.

To enlarge the heat transfer surface, the width of the clamping straps 8 can be enlarged and the width of the material elevation 2.31 of the cell housing frame 2.3 can be correspondingly reduced compared to the battery 1 shown in FIG. 4 and FIG. 5.

An electrical contacting of the cells 2 amongst one another takes place in this exemplary embodiment by means of the damping element 2.4. A heat exchange between adjacent cells 2 and also a dissipation of heat generated in the interior of the cells 2 is facilitated via the damping element 2.4.

FIG. 11 shows the construction of such a battery 1 as a further exemplary embodiment of the invention in a schematised spatial view. The battery 1 of this exemplary embodiment can be understood as a modification of the battery shown in FIG. 4 and FIG. 5, so that with respect to the fundamental construction, reference is made to the explanations relating thereto.

The battery 1 is constructed from thirty five individual cells 2. The individual cells 2 are secondary cells (accumulator cells) with active regions which contain lithium, and are constructed as frame flat cells according to FIG. 9 or FIG. 10.

A cooling plate 3 for controlling the temperature of the cells 2 is arranged below the cells 2. The cooling plate 3 has a cooling channel (not illustrated in any more detail) in its interior, through which a coolant can flow, and also two coolant connections 3.1 for supplying and draining the coolant. The cooling plate 3 can be connected via the coolant connections 3.1 to a coolant circuit which is not illustrated, by means of which coolant circuit the waste heat accepted by the coolant can be dissipated from the battery 1.

Arranged between the cooling plate 3 and the base surfaces of the cells 2 or the lower folded edges 2.12 of the cell housing side walls 2.1 is a heat-conducting film 4 made up of electrically insulating material, which electrically insulates the cooling plate 3 from the cells 2. Arranged above the cells 2 is a pressure plate 5 produced from a metal such as for example steel, aluminium or the like, wherein an electrically insulating coating (not illustrated in any more detail) is provided on the underside. Further alternatively, the pressure plate 5 can be produced from an electrically insulating material with good heat conducting properties, such as for example a reinforced plastic with heat conducting doping.

Located at a front end of the cell composite is a front pole plate 6, and a rear pole plate 7 is arranged at a rear end of the cell composite. The pole plates 6 and 7 in each case form a pole of the battery 1 and in each case have a lug-like elongation 6.1, 7.1 protruding beyond the pressure plate 5 in each case, which in each case form a pole contact of the battery 1. Further, the pole plates 6 and 7 in each case have two fixing noses (cf. 6.2, 7.2 in FIG. 3), which are angled parallel to the pressure plate 5 of the respective pole plate 6, 7 and bear against the pressure plate 5 and are electrically insulated from the pressure plate 5.

The pressure plate 5, the cells 2, the pole plates 6, 7 and the cooling plate 3 are pressed against one another by means of two clamping straps 8 which are in each case guided around the pressure plate 5, the pole plates 6, 7 and the cooling plate 3. the clamping straps 8 clamp vertically running planes with respect to the battery 1 and are therefore also termed vertical clamping straps 8.

the clamping straps 8 are constructed from a good heat conductor such as for example spring steel and have an electrically insulating, but heat conducting or heat permeable coating. Alternatively, an electrically insulating intermediate layer similar to the heat-conducting film 4 can be arranged between the pressure plate 5 and the cells 2. The vertically running clamping straps 8 have heat conducting planar contact with the pressure plate 5 and the cooling plate 3.

Due to the heat-conducting properties of the vertical clamping straps 8 and the pressure plate 5 and the heat-conducting contact of the pressure plate 5 with the upper narrow sides of the heat-conducting elements 15 accommodating the cells 2 and the vertical clamping straps 8, heat compensation in the upper region of the battery between the cells 2 and also heat transport from the upper side to the cooling plate 3 located on the underside can also take place.

The pressure plate 5 is constructed at least to some extent from an electrically insulating support material, preferably from plastic with an optional glass fibre reinforcement in one embodiment and supports electrical components for monitoring and/or controlling the battery functions and also conductor tracks, which are not illustrated in each case. Electrical components of this type are for example cell voltage monitoring elements and/or cell voltage compensation elements for compensating different charge levels of cells, which are present for example on the printed circuit board in the form of microchips, and/or temperature sensors for monitoring a temperature of the cells 2. At least in regions against which the clamping straps 8 bear, the pressure plate 5 has good heat conduction properties; zones of this type can also be termed heat conduction zones. The pressure plate 5 is in this case preferably further constructed in such a manner that heat producing and/or heat sensitive switching elements can be arranged in the vicinity of the of the heat-conducting zone and/or in heat-conducting contact with the heat-conducting zone. Particularly preferably, the printed circuit board itself has good heat conduction properties and forms the pressure plate 5 as such. In a further design variant, the pressure plate 5 can be constructed completely from a material with good heat conduction properties, wherein a printed circuit board as described previously is provided in regions against which no clamping straps 8 bear.

In this exemplary embodiment, the clamping device is realised by means of two clamping straps 8, which are provided with an electrically insulating, but heat conducting layer. Alternatively to a coating, electrically insulating, but heat conducting or heat permeable intermediate layers such as the heat-conducting film 4 can also be between the vertical clamping straps 8 and the pole plates 6, 7.

In a design variant, the clamping straps 8 can be produced from a non-conducting material, for example from a heat conducting plastic, preferably with a glass fibre, kevlar or metal reinforcement and a further heat-conducting filler material. In such a case, an additional insulation under is not required under certain circumstances.

In this exemplary embodiment, the clamping straps 8 in each case have a clamping region which is constructed as a wave-like expansion region in the design variant illustrated. Instead of an expansion region of the clamping straps 8, a crimping method can also be applied, in order to tension the clamping straps and securely connect the ends to one another. In a further design variant, toggle closures, screw closures or a comparable type of turnbuckle can be provided.

The clamping straps 8, in a design variant, the rear pole plate 7, the cooling plate 3 and the front pole plate 6 can run in depressions above the pressure plate 5, which are not illustrated in any more detail.

FIG. 12 shows the construction of a battery cell 2 as a further exemplary embodiment of the present invention in a schematic spatial view.

The battery cell 2 of this exemplary embodiment is a so-called coffee bag or pouch cell, the flat, approximately cuboidal electrode stack (active part) of which is wrapped in a film which is sealed in the boundary region and forms a so-called sealing seam 2.7. Current contacts 2.6 of the cell 2 extend through the sealing seam 2.7 at passage regions 2.71. The current contacts 2.6 of the cell 2 are arranged on opposite narrow sides, preferably the shorter narrow sides of the cell 2 in this exemplary embodiment. A fold 2.72 is constructed at the other narrow sides of the sealing seam 2.7.

Damping elements 2.4 are attached, e.g. adhesively bonded or the like, as elastic means (cushion) on the flat sides of the cell 2. The damping elements 2.4 are used for elastically supporting the cell 2 with respect to other cells or a battery housing frame or a frame element and are suitable to compensate thermal expansions or cushion impacts. The damping elements 2.4 have good heat conduction properties, but they are non-electrically conductive. To this end, a resilient material, which is itself not constructed in a particularly heat-conducting manner, such as for example PU foam, foam rubber or the like is arranged in an shell (film or the like) which conducts heat well. The shell is preferably constructed in a self flexible or bellows-like manner, in order to be able to follow the movements of the resilient material.

In a modification, the resilient material, which can be arranged in a special shell but does not have to be, has inherent heat-conducting properties. This is for example a heat-conducting gel, an arrangement of metal springs, chips or the like, or a foam doped with metal particles.

Incidentally, the explanations on the basis of FIG. 6 to FIG. 8 can be called upon analogously for the damping elements 2.4.

Due to the heat-conducting properties of the damping elements 2.4, a thermal compensation between adjacent cells can be facilitated. In the event that heat-conducting means, such as for example heat-conducting plates or the like, are arranged between adjacent cells 2, an effective heat dissipation from a cell composite from cells 2 can also be realised without having to provide an active cooling in the interior of the cell composite.

FIG. 13 shows a battery 1 with a plurality of cells 2 according to FIG. 12 as a further exemplary embodiment of the present invention in a spatial view.

According to the illustration in FIG. 13, a plurality of cells 2 are arranged between two holding frames 16, 16 or 16, 17 in each case. The arrangement made up of cells 2 and holding frames 16, 17 is arranged between two end plates 18, 19. Four tie bolts 20 with locknuts 21 are provided for clamping the composite made up of cells, holding frames 16, 17 and end plates 18, 19.

The end plates 18, 19 are also used as electric poles of the battery 1. Corresponding connection devices 23, 24 are provided for connection. A control device 26 attached to struts 25 is provided for monitoring state parameters of the battery 1 and the individual cells 2, for charge compensation and the like. In order to prevent a short circuit between the end plates 18, 19, the tie bolts 20 and/or the locknuts 21 are electrically insulated with respect to at least one of the end plates 18, 19.

The cells 2 are constructed as so-called coffee bag or pouch cells according to FIG. 12 in this exemplary embodiment. The cells 2 are gripped by the holding frames 16, 17 on the contacts themselves or in the passage regions 2.71 and emit heat to the frame elements 16, 17 at this point. Further, heat-conducting films (not illustrated in any more detail) are arranged between the damping elements 2.4 of a cell 2 and an empty flat side 2.8 of an adjacent cell 2, which films extend upwards and downwards as far as into the region of the fold 2.72 of the sealing seam 2.7 and are there clamped between the fold 2.72 and a respective holding frame 16, 17. In this manner, heat can also be emitted from the cell interior to the frame elements 16, 17 via the flat sides 2.8, the damping elements 2.4 and the heat-conducting films, which are not illustrated in any more detail. The heat can be dissipated from the frame elements 16, 17 forming a compact block by means of convection or heat sinks, such as for example a cooling plate, for example as shown inter alia in FIG. 5.

In a design variant, the tie bolts 20 accept heat from the frame elements 16, 17, in order to conduct the same outside. To this end, they are in heat-conducting contact with the end plates 18, 19. The heat can be conducted away via the end plates 18, 19 by means of a suitable cooling device (not illustrated in any more detail). The tie bolts run through the frame elements 16, 17 and accept heat from the holding frames 16, 17. Alternatively, separate contact elements can be provided, which are gripped by the holding frames 16, 17 and exert the compressive force onto the boundary sections of the cells 2 and accept heat from the same. For example, a profile made from aluminium or another good heat conductor, around which air flows and which is screwed by means of tie bolts on the head side and/or the nut side to the end plates 18, 19, is considered as cooling device. Alternatively, a cooling plate with or without circulating heat transfer medium, to which the tie bolts 20 can emit heat, can also be attached at the end on one or both of the end plates 18, 19. Other types of heat dissipation via the tie bolts 20 are also conceivable.

In further design variants, more than four tie bolts, e.g. six or eight tie bolts can be provided in order to clamp the cell block and dissipate heat.

Alternatively, in the case of this shape of a cell block, the clamping can also take place for example by means of heat-conducting clamping straps (cf. FIG. 11). In a further design variant, such clamping straps can for example but not only be guided via bevels 16.1, 17.1, 18.1, 19.1 of the holding frames 16, 17 and the end plates 18, 19.

A galvanic cell or battery cell (individual cell) 2 realised as a flat cell and a heat-conducting element 14 corresponding thereto is illustrated in FIG. 14 and FIG. 15, wherein FIG. 14 shows a perspective view and FIG. 15 shows a cross-sectional view of the individual cell 2 and the heat conducting element 14.

The individual cell 2 has a housing, which is not described in any more detail and surrounds an electrode stack which is not illustrated in any more detail here. The housing has two film layers which are welded in a boundary region, in order to construct a so-called sealing seam 2.7, in order to surround the electrode stack in a gas- and liquid-tight manner. The electrode stack manifests itself as a thickening of the individual cell 2. The parts of the housing connecting to the flat sides of the electrode stack in a stack direction s can also be understood to be housing side walls 2.1, 2.2 in the sense of the definition in FIG. 1ff.

The electrode stack is constructed similarly to the electrode stack 2.5 illustrated in FIG. 2; but contact lugs protrude in a laterally offset manner depending on the polarity in each case on a single narrow side (here the upper side) of the electrode stack and are connected still within the housing to current contacts 2.6 which extend through the sealing seam 2.7 to the outside and construct pole contacts P+, P− of the cell 2. In a design variant, contact lugs of the electrode stack itself combined according to polarity can be guided as current contacts 2.6 through the sealing seam 2.7 to the outside.

A damping element 2.4 is arranged on one of the housing side walls, here the housing side wall 2.2. The damping element 2.4 is formed integrally with the housing side wall 2.2 in this exemplary embodiment. Specifically, the housing side wall has an inner envelope 2.2a and an outer envelope 2.2b, which are for example formed from a film material and can be understood as an analogy to the envelopes 2.41, 2.42 of the damping element 2.4 according to FIG. 6. A cavity 2.44, which is filled with an elastically resilient and heat-conducting material extends between the inner envelope 2.2a and the outer envelope 2.2b; reference may be made to the statements for FIG. 6 for possible design variants. In contrast with the damping element 2.4 shown in FIG. 6, reference is to be made to the fact that in the present exemplary embodiment, the outer envelope 2.2b is not electrically conductive and that the filling of the cavity 2.44 is heat conductive.

The heat-conducting element 14 is constructed in this exemplary embodiment as a heat-conducting plate of width w and height h with a long leg 14.11 and a short leg 14.12, wherein the short leg 14.12 is angled by about 90° from the long leg 14.11 in an L-shaped manner and has a length d. The underside of the short leg 14.12 forms a cooling contact surface A1 which can be cooled in the manner described in more detail below.

The long leg 14.11 of the heat-conducting element 14 has a thickness b and has a cell contact surface A2, which bears against the first housing side wall 2.1 of the individual cell 2. As a result, a heat flow W from the individual cell can be conducted over a large area through the cell contact surface A2 to the long leg 14.11 of the heat-conducing element 14 and from there to the short leg 14.12 thereof and via the short leg 14.12 can be dissipated by means of the cooling contact surface A1 thereof. At the same time, in a stack arrangement of a plurality of cells 2 and heat-conducting elements 14 in a further heat flow, which is not illustrated in any more detail, heat can be emitted from the interior of the cell 2 via the heat-conducting damping elements 2.4 at the long leg 14.12 of a heat-conducting element 14 and dissipated via the short leg thereof 14.12 by means of the cooling contact surface A1 thereof.

In an illustration corresponding to FIG. 15, FIG. 16 shows an individual cell 2 and a heat-conducting element 14 according to a further exemplary embodiment of the invention in a cross-sectional view.

The individual cell 2 is constructed similarly to the individual cell in FIGS. 14 and 15. The individual cell 2 of this exemplary embodiment is missing a damping element (2.4 in FIG. 14 or 2.2a, 2.2b, 2.44 in FIG. 15), however. Instead, the heat-conducting element 14 has a damping element 14.2 on a side of the long leg 14.11 facing away from the individual cell 2.

The damping element 14.2 has good heat conduction properties. To this end, a resilient material, which is itself not constructed in a particularly heat-conducting manner, such as for example PU foam, foam rubber or the like is arranged in a shell (film or the like) which conducts heat well. The shell is preferably constructed in a self flexible or bellows-like manner, in order to be able to follow the movements of the resilient material.

In a modification, the resilient material, which can be arranged in a special shell but does not have to be, has inherent heat-conducting properties. This is for example a heat-conducting gel, an arrangement of metal springs, chips or the like, or a foam doped with metal particles.

In a further modification, the damping element 14.2 can be applied directly to the long leg 14.11 as a heat-conducting damping layer.

Due to the heat conducting properties of the damping elements 14.2, a thermal compensation between adjacent cells 2 can be facilitated and an effective heat dissipation from a cell composite made up of cells 2 can be realised without having to provide an active cooling in the interior of the cell composite.

FIG. 17 shows an individual cell 2 and a heat-conducting element 14 according to a further exemplary embodiment of the invention in a spatial exploded illustration.

The individual cell 2 is constructed like the individual cell in FIG. 16. The heat-conducting element 14 is likewise constructed substantially like the heat-conducting element 14 in FIG. 16; but the heat-conducting element 14 in this exemplary embodiment has a damping element 14.2 on a side of the long leg 14.11 facing the individual cell 2. With respect to details of the damping element 14.2, reference may be made to the explanations of FIG. 21.

In an illustration corresponding to FIG. 17, FIG. 18 shows an individual cell 2 and a heat-conducting element 14 according to a further exemplary embodiment of the invention in a spatial exploded illustration.

The individual cell 2 is constructed like the individual cell in FIG. 17. The heat-conducting element 14 is likewise constructed substantially like the heat-conducting element 14 in FIG. 16 or 17; but the heat-conducting element 14 in this exemplary embodiment has a damping element 14.2 on both flat sides of the long leg 14.11. With respect to details of the damping elements 14.2, reference may be made to the explanations for FIG. 21.

FIG. 19 and FIG. 20 show a battery 1 with a plurality of individual cells 2 described on the basis of FIG. 14 to FIG. 18 and heat-conducting elements 14 arranged between the same, wherein the battery 1 is shown in an exploded illustration in FIG. 19 and in a mounted state in FIG. 20. The individual cells 2 are combined to form a cell composite Z.

To cool the battery 1, a cooling plate 3 is arranged on the individual cells 2 at the bottom. In this case, the short legs 14.12 of the heat-conducting elements 14 are connected in a heat-conducting manner, namely by means of planar contact, to the cooling plate 3. As a result, heat transferred from the individual cells 2 to the associated heat-conducting elements 14 is dissipated to the cooling plate 3 if the temperature thereof is lower than the temperature of the heat-conducting elements 14.

The heat-conducting elements 14 are pressed by means of clamping straps 8, particularly clamping belts, with the individual cells 2 and fixed on the cooling plate 3. To this end, the cooling plate 3 has notchings 3.2 in the longitudinal direction on a side facing away from the cell composite Z, which notchings correspond to the dimensions of the clamping element 8, particularly the width and height thereof. The number of notchings 3.2 corresponds in particular to the number of clamping elements 8 which are used for fixing the cell composite Z.

The cooling plate 3 further has a coolant connection unit 3.10 with at least one inlet opening 3.11 and at least one outlet opening 3.12, via which a coolant or heat transfer agent can be supplied to or removed from the cooling plate 3. The cooling plate 3 can be connected to a coolant circuit, for example a coolant circuit of an air conditioning unit of a motor vehicle, which is not illustrated, by means of the coolant connection unit 3.10. The coolant, which dissipates the heat accepted via the coolant circuit, flows in the coolant circuit.

FIG. 21 shows the construction of a heat-conducting element as a further exemplary embodiment of the present invention in a cross-sectional view.

The heat-conducting element 14 of this exemplary embodiment has a support structure 14.1 and two damping elements 14.2. The support structure 14.1 is produced from a material which conducts heat well, such as for example aluminium or a different metal, a heat-conducting plastic or the like. In cross section, it has the shape of a T profile with a long leg 14.11 and two short legs 14.12. The long leg 14.11 is provided for arrangement between battery cells 2 (illustrated as dashed outlines 2) of a cell composite, in order to accept heat produced in the battery cells 2. The short legs 14.12 are provided for bearing against a heat-conducting plate 3 (illustrated as a dotted outline 3) or the like, in order to emit the heat accepted from the battery cells 2.

The damping elements 14.2 are arranged, e.g. adhesively bonded or the like, on both sides of the long leg 14.11. The damping elements 14.2 are used for elastically supporting the cells 2 with respect to one another and are suitable to compensate thermal expansions of the cells 2 or cushion impacts. Incidentally, with respect to properties of the damping elements 14.2, reference is made to the explanations for the damping element 14.2 in the heat-conducting element 14 according to FIG. 16.

In a modification, the damping elements 14.22 can extend onto the short legs 14.12 in order in particular to also achieve a downward cushioning in the case of frame flat cells.

An electrically insulating heat-conducting film or the like can be provided between the short legs 14.22 and the cooling plate 3.

The heat-conducting element 14 of this exemplary embodiment can be used in a battery 1, as is illustrated in FIG. 4 and FIG. 5, between cells 2 which do not have any spring elements themselves.

For use with cells, the flat sides of which are constructed as cell poles, both the damping elements 14.2 and the carrier structure 14.1 are constructed in an electrically conductive manner. At points within a battery, at which a series connection of cells of this type should be interrupted, both for use with cells in which cell poles are constructed differently, for example by means of lug-like contacts, at least the damping elements 14.2 can be constructed in an electrically insulating manner.

FIG. 22 shows a heat-conducting element 15 with a galvanic cell (individual cell) 2 constructed as a frame flat cell as a further exemplary embodiment of the present invention in a spatial view, wherein the frame flat cell 2 and the heat-conducting element 15 are illustrated separately from one another for the purpose of explanation.

According to the illustration in FIG. 22, the cell 2 is constructed similarly to the cells 2 in FIG. 1 to FIG. 3 or FIG. 9 or FIG. 10. However, the cell housing side parts 2.1, 2.2 do not have any bent sections (2.12, 2.13 or 2.22 in FIG. 6 or FIG. 8) and none of the cell housing side parts 2.1, 2.2 carries a damping element. The cell housing side parts 2.1, 2.2 are therefore essentially constructed as planar plates, the height and width of which essentially correspond to those of the cell housing frame 2.3 without the material elevation 2.31. It may be mentioned that the invention in the embodiment of this exemplary embodiment is also functional if the cell housing side parts 2.1, 2.2 of the cell 2 have bent sections and/or spring elements.

The heat-conducting element 15 is constructed as a flat box with a base 15.1 and a narrow peripheral boundary 15.2. In this case, the base 15.1 forms a first flat side of the heat-conducting element 15 and the boundary 15.2 forms four narrow sides of the heat-conducting element, whilst an exposed edge 15.20 of the boundary 15.2 defines a second, open flat side of the heat-conducting element 15. The heat-conducting element 15 is produced in the present exemplary embodiment as a deep drawn part made of a material with good electrical and thermal conductor properties, preferably of aluminium or steel or another metal.

The boundary 15.2 has a material recess 15.3 in an upper region in the centre. The width of the material recess 15.3 corresponds to the width of the material elevation 2.31 of the cell housing frame 2.3 of the cell 2 with play. The internal dimensions, particularly the internal height and internal width of the heat-conducting element 15 are adapted with little play to the external dimensions of the cell 2, so that the cell 2 finds space in the interior of the heat-conducting element 15 and can be inserted without force (cf. arrow “F” in FIG. 21). If the cell 2 heats up during operation and expands as a result, the cell housing may then bear securely against the boundary 15.2 of the heat-conducting element 15. The height of the boundary 15.2 is dimensioned in such a manner in this case that if the cell 2 bears by means of its cell housing side wall 2.2 against the base 15.1 of the heat-conducting element 15, the boundary 15.2 does not reach the other cell housing side wall 2.1.

A damping element 15.5 is arranged on the internal surface of the base 15.1. With respect to the properties of the damping element 15.5, reference may be made to the explanations for damping elements 2.4, 14.2 according to the previous description.

A plurality of cells 2 with heat-conducting element 15 can be combined similarly to the manner illustrated in FIG. 4 and FIG. 5 to form a cell block or a battery. In this case, the heat-conducting elements 15 on the one hand act as contacting between contact sections K1, K3 of successive cells, on the other hand, they transport heat generated in the interior of the cells 2 via the damping elements 15.5 and the base 15.1 to the edges 15.2, which are exposed on the outside, where the heat is either emitted directly to a cooling plate or can be conducted via clamping devices to a cooling plate. Analogously to the previously described exemplary embodiments, provision is to be made for electrical insulation between the heat-conducting elements 15 and the cooling plate or the clamping straps (cf. 8 in FIG. 5 inter alia), in order to prevent faulty contacting.

In a design variant, the internal dimensions of the heat-conducting element 15 are not dimensioned with play, but rather with a slight undersizing with regards to the external dimensions of the cells 2, so that the heat-conducting element 15 and the cell 2 are to be joined with a certain force.

Although it is not illustrated in any more detail in the figure, depressions can be provided, which can be used for accommodating and guiding clamping straps.

FIG. 23 shows a modification of the heat-conducting element 15 according to FIG. 22 in a schematised spatial view.

According to the illustration in FIG. 23, the boundary 15.2 of the heat-conducting element has interruptions (cuts) 15.4 at the edges thereof, so that the continuous boundary 15.2 (FIG. 21) is divided into two lateral boundary sections 15.21, a lower boundary section 15.22 and two upper boundary sections 15.23. If the boundary is dimensioned with undersizing with respect to the cell 2, a joining force can be lower in this modification, as the boundary sections 15.21, 15.22, 15.23 can yield in a resilient manner. During production, the heat-conducting element 15 can initially be stamped or cut out of a flat sheet metal part and then bent into shape. Alternatively, the heat-conducting element 15 can be deep drawn and then cut out.

As a further modification, four damping elements 15.5 are provided here, which are distributed over the internal surface of the base 15.1. With regards to the properties of the elastic elements 15.5 of this modification, the explanations for the damping elements 2.4 or 14.2 can be applied analogously.

FIG. 24 shows the construction of a battery 1 as a further exemplary embodiment of the invention in a schematised spatial view. The battery 1 is constructed from thirty five individual cells 2., which are in each case accommodated in a heat-conducting element 15 according to FIG. 22 or FIG. 23. The individual cells 2 are secondary cells (accumulator cells) with active regions which contain lithium, and are constructed as frame flat cells according to FIG. 22. Incidentally, the battery 1 of this exemplary embodiment can be understood as a modification of the battery shown in FIG. 4 and FIG. 5, so that with respect to the fundamental construction, reference is made to the explanations relating thereto.

In addition to the vertical clamping straps 8 which are constructed from a heat-conducting material and can conduct heat from the upper side of the battery to the cooling plate 3, a further clamping strap 9 is also provided, which runs over the lateral sides of the individual cells 2 or the heat-conducting elements 15 and surrounds the battery 1 in a horizontal plane; it is therefore also termed a horizontal clamping strap 9. With respect to the properties of the horizontal clamping strap 9, reference may be made to the explanations for the vertical clamping straps 8 according FIG. 11. In particular, the horizontal clamping strap 9 is also constructed in a heat conducting manner. The horizontal clamping strap 9 covers the clamping straps 8 in the region of the pole plates 6, 7. In an alternative realisation, the clamping straps 8 can cover the clamping strap 9. In the region of the lateral narrow sides of the heat-conducting elements 15, the horizontal clamping strap has flat heat-conducting contact with the same and further has flat heat-conducting contact with the vertical clamping straps 8 in the region of the pole plates 6, 7.

Due to the heat-conducting properties of the horizontal clamping strap 9 and the heat-conducting contact of the horizontal clamping strap 9 with the lateral narrow sides of the heat-conducting elements 15 accommodating the cells 2 and the vertical clamping straps 8, heat compensation in the lateral region of the battery between the cells 2 and also heat transport from the lateral side via the vertical clamping straps 8 to the cooling plate 3 located on the underside can also take place.

Like the clamping straps 8, 9, the clamping strap 9 can have an electrically insulating, but heat conducting or heat permeable coating. Alternatively, an electrically insulating intermediate layer similar to the heat-conducting film 4 can be arranged between the pressure plate 5 and the cells 2 or the upper narrow sides of the heat-conducting elements 15. Alternatively, heat conducting or heat permeable intermediate layers, such as for example the heat-conducting film 4 can also be provided between the vertical clamping straps 8 and the pole plates 6, 7, between the horizontal clamping strap 9 and the heat-conducting elements 15 and also between the horizontal clamping strap 9 and the pole plates 6, 7. Electrical insulation between the heat-conducting elements 15 on the one hand and the cooling plate 3, the pressure plate 5 and the clamping strap 9 on the other hand is not required if the external sides of the edges of the heat-conducting elements 15 carry an electrically insulating layer for their part as a further design variant.

In a further design variant, the clamping strap 9 can run in depressions, which are not illustrated in any more detail, in the lateral narrow sides of the heat-conducting elements 15 and the front and rear pole plates 6, 7. In a further variant, pressure plates (not illustrated in any more detail) can also be provided between the clamping strap 9 and the lateral narrow sides of the heat-conducting elements 15.

FIG. 25 shows the construction of a battery 1 as a further exemplary embodiment of the present invention in a schematic illustration.

The battery 1 is constructed from a plurality of individual cells (cells) 2 which are arranged in three rows R1 to R3. A first row R1 is arranged adjoining a battery housing wall 27, whilst the rows following the same are in each case arranged at a distance of one row width further from the battery housing wall 27. One cell 2 from each row R1 to R3 is illustrated in the figure, whilst the further cells of the rows are symbolised by dots. Battery cells adjoining one another transversely to the direction of extent of the rows R1 to R3 define a column Sᵢ of cells 2.

The cells 2 of the battery 1 of this exemplary embodiment are cylindrically constructed cells 2. The cells 2 of a column Sᵢ are fixed by means of a looped fixing strap 28 on the battery housing wall 27. The fixing strap 28 runs from the battery housing wall 27 and surrounds the cells 2 of the column Sᵢ initially in a wave-shaped manner as far as the cell 2 of the most remote row R3, surrounds the same further in a loop and then runs back to the battery housing wall 27, wherein it in turn surrounds the cells 2 of the column Sᵢ in a wave-shaped manner in the reverse order to before. In this manner, the cells 2 of a column Sᵢ are held in their position.

The fixing strap 28 is produced from a heat-conducting material. By surrounding the cells 2, it is in close contact with the same, accepts heat which is generated in the cells 2 and transports the same to the battery housing wall 27. The battery housing wall 27 is actively or passively cooled or temperature controlled.

FIG. 26 shows the construction of a battery 1 as a further exemplary embodiment of the present invention in a schematic illustration. This exemplary embodiment is a modification of the exemplary embodiment illustrated in FIG. 25. Here, the cell 2 of the three rows R1 to R3 are located between two housing side walls 27.1, 27.2. Two fixing straps 28.1, 28.2 run between the housing side walls 27.1, 27.2, wherein they surround the battery cells 2 in a wave-shaped manner.

The fixing straps 28 or 28.1, 28.1 of the batteries 1 illustrated in FIG. 25 or FIG. 26 are produced from an elastically resilient material that can preferably be bent well. Thus, an elastic support is achieved between individual cells 2 among one another and with a battery housing.

It is understood that the invention is not orientated to a certain plurality of columns Sᵢ; rather, the invention according to the previously mentioned exemplary embodiments can also be applied to batteries which only have one column S of battery cells 2.

It is further understood that the invention is not limited to three rows R1 to R3 of battery cells 2; rather, the invention according to the previously described exemplary embodiments can also be applied to batteries which have more or fewer rows Ri of battery cells 2.

Although an assumption about elongated cylindrical cells 2 was made in FIG. 25 and FIG. 26, in a design variant, a stack of flat cylindrical cells, for example button cells or the like can be provided in the place thereof, which are pressed against one another in the axial direction by means of a further clamping device which is not illustrated.

The invention was previously described on the basis of preferred exemplary embodiments, design variants and alternatives, as well as modifications, which for their part are likewise to be understood as preferred exemplary embodiments of the invention. To avoid unnecessary repetitions, where appropriate, reference is made to explanations for other exemplary embodiments, variants, etc. It may be stressed again that everywhere where it is not clearly stated, features and properties of an exemplary embodiment, a variant, alternative or modifications can be applied at least analogously to a different exemplary embodiment, a different variant, alternative or modification.

All cells or individual cells 2 of the previous description are storage cells or energy storage cells in the sense of the invention. All batteries 1 of the previous description are storage devices in the sense of the invention. All damping elements 2.4, 14.2, 15.5 and also the fixing straps 28, 28.1, 28.2 of the previous description are elastic means in the sense of the invention. The latter fixing straps 28, 28.1, 28.2 are also a clamping device in the sense of the invention, as well as the clamping straps 8, 9 and the tie bolts 20 with nuts 21, holding frames 16, 17 and pressure frames 18, 19 of the previous description. All constituents which are associated with heat dissipation, particularly cooling plates 3, heat-conducting elements 14, 15 and all heat-conducting damping elements 2.4, 14.2, 15.5 of the previous description are functional constituents of a temperature control device in the sense of the invention. Cooling plates 3 of the previous description are heat exchanger devices in the sense of the invention. Envelopes 2.41, 2.42, an inner envelope 2.2a, an outer envelope 2.2b of the previous description are heat-conducting shells in the sense of the invention.

### LIST OF REFERENCE NUMBERS

1 Battery

2 Cell

2.1 Cell housing side wall

2.11 Measuring connection

2.12 Folded edge

2.13 Tab

2.2 Cell housing side wall

2.2a Inner envelope

2.2b Outer envelope

2.4 Damping element

2.22 Tab

2.3 Cell housing frame

2.31 Material elevation

2.32 Upper narrow side

2.33, 2.34 Material recess

2.4 Damping element

2.41, 4.42 Envelope

2.43 Seam

2.44 Interior

2.45 Bellows structure

2.46 Foam block

2.5 Electrode stack

2.51 Electrode film

2.52 Contact lug

2.6 Pole contact (current contact)

2.7 Sealing seam

2.71 Passage region

2.72 Fold

2.8 Flat side

3 Cooling plate

3.1 Coolant connection

3.2 Depression

3.3 Cooling channel

4 Heat-conducting film

5 Pressure plate

5.1 Depression

6 Front pole plate

7 Rear pole plate

6.1, 7.1 Lug-like elongation

6.2, 7.2 Fixing nose

7.3 Depression

8 Clamping element (Vertical clamping strap)

8.1 Clamping region

9 Horizontal clamping strap

10, 11 Electrical connection element

13 Electronic component

13.1 Device for monitoring cell voltage

13.2 Device for compensating cell voltage

13.3 Contact element

14 Heat-conducting element

14.1 Carrier structure

14.11 Long leg

14.12 Short leg

14.2 Damping element

14.21 Resilient material

14.22 Shell

15 Heat-conducting element

15.1 Bottom

15.2 Boundary

15.20 Edge

15.21, 15.22, 15.23 Boundary sections

15.3 Recess

15.4 Cuts

15.5 Damping element

16 Base plate

16, 17 Holding frame

16.1, 17.1 Bevel

18, 19 End plates

18.1, 19.1 Bevel

20 Tensioning bolt

21 Nut

22, 23, 24 Connection device

25 Strut

26 Control device

27, 27.1, 27.2 Housing wall

28, 28.1, 28.2 Fixing strap

A1 Cooling contact surface

A2 Cell contact surface

B Bending direction

D Compressive force

E1 First cell

E2 Last cell

F Joining direction

K1 to K3 Voltage connection contacts

P+ Positive pole

P− Negative pole

P_{neg} Negative pole connection

Pₚₒₛ Positive pole connection

R1 bis R3 Cell rows

Sᵢ Cell column

W Heat flow

Z Cell composite

b, w Width

d Thickness

h, h1, h2 Height

s Stack direction

t Depth, thickness

It is pointed out that the preceding list of reference numbers is an integral part of the description.

1-15. (canceled)

16. An energy storage apparatus, comprising:
a plurality of storage cells; and
a temperature control device for controlling the temperature of the storage cells or a cell composite formed by the storage cells,
and elastic means for shock absorbing storage or spacing, the elastic means provided between a storage cell and another component, wherein the other component is a different storage cell or a holding element or some other housing part or a heat-conducting element, wherein the elastic means are designed and configured as a functional constituent of the temperature control device,
wherein
the cell housing side walls (2.1, 2.2) of at least one storage cell (2) are electrically conductively realised and form poles (P+, P−) of the storage cell (2), and
the elastic means are constructed at least partially as electrically conductive damping elements which have a heat-conducting shell and an interior, wherein the interior is filled with a heat-conducting and elastically resilient material.

17. The energy storage apparatus according to claim 16, wherein the elastic means abut on heat exchange surfaces of the storage cells, at least in certain sections.

18. The energy storage apparatus according to claim 17, wherein the elastic means abut on heat exchange surfaces of the storage cells planarly.

19. The energy storage apparatus according to claim 16, wherein the elastic means are constructed in an electrically insulating manner.

20. The energy storage apparatus according to claim 16, wherein the elastic means are fixed on respective storage cells or constructed as an integral constituent of respective storage cells.

21. The energy storage apparatus according to claim 16, wherein the elastic means are fixed on respective heat-conducting elements, which are arranged at least in certain sections between respective storage cells, or constructed as an integral constituent of such heat-conducting elements.

22. The energy storage apparatus according to claim 16, wherein the temperature control device includes a heat exchanger device and heat-conducting elements, which are arranged at least in certain sections between respective storage cells and have heat-conducting contact with the heat exchanger device.

23. The energy storage apparatus according to claim 16, wherein a clamping device is provided for clamping the storage cells.

24. The energy storage apparatus according to claim 23, wherein the clamping device is designed and configured as a functional constituent of the temperature control device.
